(19) United States
(12) Patent Application Publication
(10) Pub. No.: US 2026/0277084 A1
(43) Pub. Date: Sep. 17, 2026

(54) PROJECTOR

(71) Applicant: Qisda Corporation, Taoyuan City (TW)

(72) Inventors: Hsin-Liang CHEN, Taoyuan City (TW); Chun-Ming SHEN, Taoyuan City (TW)

(73) Assignee: Qisda Corporation, Taoyuan City (TW)

(21) Appl. No.: 19/560,353

(22) Filed: Mar. 9, 2026

(30) Foreign Application Priority Data
Mar. 17, 2025 (CN) 202510309625.4

(51) Int. Cl. G03B 21/14

(52) U.S. Cl. CPC G03B 21/145

(57) ABSTRACT

This invention provides a projector for use in a mobile carrier. The projector includes an optical engine module and an adjustment module. The adjustment module is connected to the optical engine module and includes a knob. When the knob is in a first state, the optical engine module is allowed to rotate about a first axis; when the knob is in a second state, the optical engine module is allowed to rotate about a second axis. As a result, by operating the same knob in different states, the optical engine module may be driven to rotate about different axes.

This application claims the benefit of People’s Republic of China application Serial No. 202510309625.4, filed on March 17, 2025, the subject matter of which is incorporated herein by reference.

### BACKGROUND OF THE INVENTION

### FIELD OF THE INVENTION

The invention relates in general to a projector disposed in a mobile carrier.

### DESCRIPTION OF THE RELATED ART

Vehicle lighting systems are becoming increasingly diverse, and a small projector which is integrated into an interior of the vehicle interior and projecting an ambient lighting or a dynamic information is gradually becoming a mainstream design approach. However, due to space constraints within the vehicle, the user interface of the vehicle projector should not be designed to be overly complex.

Therefore, it is necessary to design a new type of the projector to overcome the above-mentioned shortcomings.

### SUMMARY OF THE INVENTION

A purpose of the present invention is to provide a projector that may drive an optical engine module to rotate around different axes by operating the same knob in different states.

According to an embodiment of the present invention, a projector adapted to be disposed on a mobile carrier is provided. The projector includes an optical engine module and an adjustment module. The adjustment module is connected to the optical engine module and includes a knob. Based on the knob being in a first state, the optical engine module is allowed to rotate about a first axis. Based on the knob being in a second state, the optical engine module is allowed to rotate about a second axis, wherein the first axis and the second axis have different directions.

Preferably, the adjustment module includes a first housing, a first engagement element and a clutch. The first engagement element is rotatably disposed in the first housing. The clutch is connected to the knob, slidably disposed relative to the first housing and includes a second engagement element. Based on the knob being in the first state, the second engagement element engages with the first engagement element; based on the knob being in the second state, the second engagement element disengages from the first engagement element.

Preferably, the first engagement element and the second engagement element are gears.

Preferably, the adjustment module further includes a third engagement element rotatably disposed on the first housing and engaged with the first engagement element.

Preferably, the first engagement element, the second engagement element and the third engagement element are gears.

Preferably, the adjustment module further includes a first threaded rod connected to the third engagement element, and the projector further includes a carrier disk connected to the optical engine module and having a first screw hole, wherein the first screw hole is screwed into the first threaded rod. Based on the knob being in the first state and the knob rotating, the first threaded rod rotates to drive the carrier disk and the optical engine module to rotate about the first axis.

Preferably, the adjustment module includes a sliding plate slidably disposed on the first housing. The clutch is rotatably but non-slidably connected to the sliding plate.

Preferably, the projector further includes a drive module and a pivot element. The drive module includes a second threaded rod. The pivot element is connected to the optical engine module and having a second screw hole, wherein the second screw hole is screwed into the second threaded rod. Based on the knob being in the second state, the second engagement element is engaged with the drive module; based on the knob being in the second state and the knob rotating, the second threaded rod rotates to drive the optical engine module to rotate about the second axis

Preferably, the drive module is a gear set.

Preferably, the drive module includes a plurality of gears, and the second threaded rod is connected to one of the gears which is located at an end of a power transmission path.

Preferably, the projector further includes a carrier disk and a fixing element. The fixing element is fixed to the optical engine module and rotatably pivotally connected to the carrier disk about the second axis.

Preferably, the knob has a knob engagement portion, and the adjustment module further includes a second housing having a housing engagement portion. Based on the knob being in a third state, the knob engagement portion engages with the housing engagement portion.

Preferably, the projector further includes a casing having an outer surface. Based on the knob being in the first state, the knob protrudes relative to the outer surface.

Preferably, the projector further includes a casing having an outer surface. Based on the knob being in the third state, the knob is flush with or recessed relative to the outer surface of the casing.

Preferably, the casing further has a groove, the groove is recessed relative to the outer surface, the groove has a groove length and the knob has a knob length along the same direction, and the groove length is greater than the knob length.

Preferably, the adjustment module further includes a sliding element having a first recess and a second recess and a spring piece having an end portion. Based on the knob being in the first state, the end portion of the spring piece engages with the first recess; based on the knob being in the second state, the end portion of the spring piece engages with the second recess.

Preferably, the adjustment module further includes a sliding plate having a recessed hole and a latch having an end portion. Based on the knob being in the first state or the second state, the end portion of the latch is located within the recessed hole of the sliding plate.

Preferably, the adjustment module further includes an elastic element disposed between the latch and a sliding element of the adjustment module.

Preferably, based on the knob switching from the second state to the third state, the end portion of the latch disengages from the recessed hole of the sliding plate.

Preferably, the projector further includes a V-shaped reflector module disposed relative to the optical engine module.

Preferably, the optical engine module includes a lens, and the projector further includes an adapter fixed to the optical engine module. The V-shaped reflector module is translatably disposed relative to the lens of the optical engine module.

Preferably, the projector further includes a third threaded rod rotatably connected to the adapter. The V-shaped reflector module has a third screw hole, and the third screw hole is screwed into the third threaded rod.

Compared with the prior art, the present invention provides the projector including the adjustment module and the optical engine module. The adjustment module includes the knob that can be in different states for operating different movement modes of the optical engine module. When the knob is in the first state, rotating the knob drives the optical engine module to rotate around the first axis. When the knob is in the second state, the knob is rotated to drive the optical engine module to rotate around the second axis. As a result, by operating the same knob in different states, the optical engine module can be driven to rotate around different axes.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1A shows a schematic diagram (a first state) of a projector according to an embodiment of the present invention;

FIG. 1B shows a cross-sectional view of the projector in FIG. 1A along a direction 1B-1B';

FIG. 1C shows an internal schematic diagram of the projector in FIG. 1A (a casing is omitted);

FIG. 2A shows a schematic diagram of the projector in FIG. 1A in a second state;

FIG. 2B shows an internal schematic diagram of the projector in FIG. 2A (the casing is omitted);

FIG. 3A shows a schematic diagram of the projector in FIG. 1A in a third state;

FIG. 3B shows an internal schematic diagram of the projector in FIG. 3A (the casing is omitted);

FIG. 4A shows a schematic diagram of the adjustment module in FIG. 1C (the first state);

FIG. 4B shows a cross-sectional view of the adjustment module in FIG. 4A along a direction 4B-4B';

FIG. 4C shows a cross-sectional view of the adjustment module in FIG. 4A along a direction 4C-4C';

FIGS. 4D to 4F show exploded views of the adjustment module in FIG. 4A from different perspectives;

FIG. 5A shows the adjustment module in FIG. 4A in the second state;

FIG. 5B shows a cross-sectional view of the adjustment module in FIG. 5A along a direction 5B-5B';

FIG. 5C shows a cross-sectional view of the adjustment module in FIG. 5A along a direction 5C-5C';

FIG. 6A shows a schematic diagram of the adjustment module in FIG. 5A in the third state;

FIG. 6B shows a cross-sectional view of the adjustment module in FIG. 6A along a direction 6B-6B';

FIG. 6C shows a cross-sectional view of the adjustment module in FIG. 6A along a direction 6C-6C';

FIGS. 7A to 7B show exploded views of the clutch in FIG. 6A from different perspectives;

FIG. 8A shows an assembly diagram (the first state) of the clutch, the first housing, the sliding element, the sliding plate and the spring piece in FIG. 4D;

FIG. 8B shows an assembly diagram of the sliding element and the spring piece in FIG. 8A;

FIG. 8C shows an exploded view of the sliding element and the spring piece in FIG. 8B;

FIG. 9 shows a schematic diagram of the knob in FIG. 8A in the second state;

FIG. 10 shows a schematic diagram of the knob in FIG. 9 in the third state;

FIGS. 11A to 11B show exploded views of the sliding element, the elastic element and the latch in FIG. 4D from different perspectives;

FIGS. 12A and 12B show exploded views of the V-shaped reflector module, the carrier disk, at least one fixing element, the fixing shaft and the drive module in FIG. 1C from two different perspectives;

FIG. 13A shows a schematic diagram of a projector according to another embodiment of the present invention (the housing is not shown);

FIG. 13B shows an exploded view of the projector in FIG. 13A; and

FIG. 13C shows a cross-sectional view of the projector in FIG. 13A along a direction 13B-13B'.

### DETAILED DESCRIPTION OF THE INVENTION

To provide a further understanding of the purpose, structure, features and functions of the present invention, detailed descriptions are provided below with reference to embodiments.

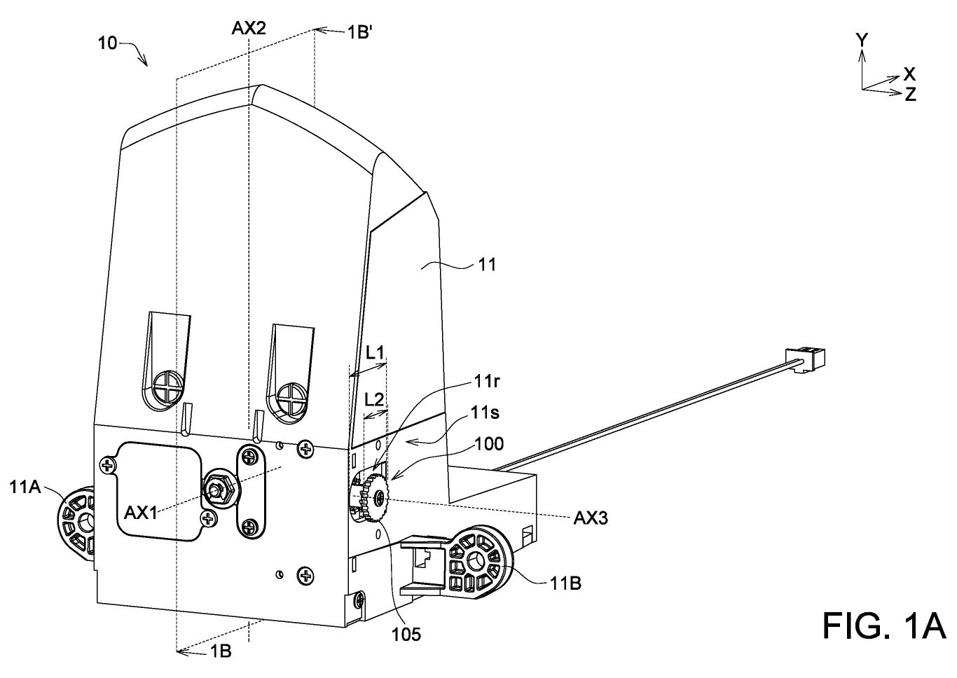

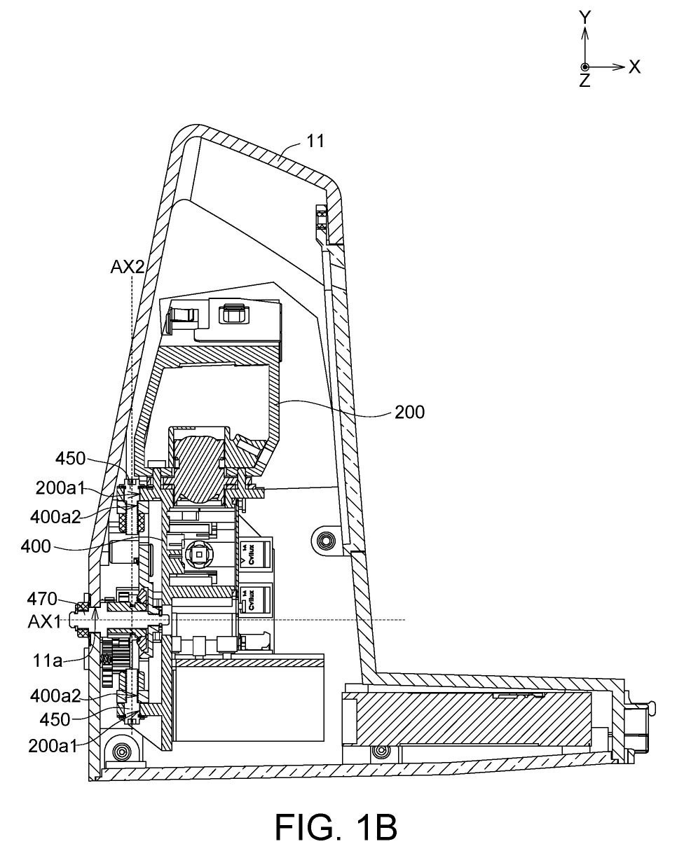

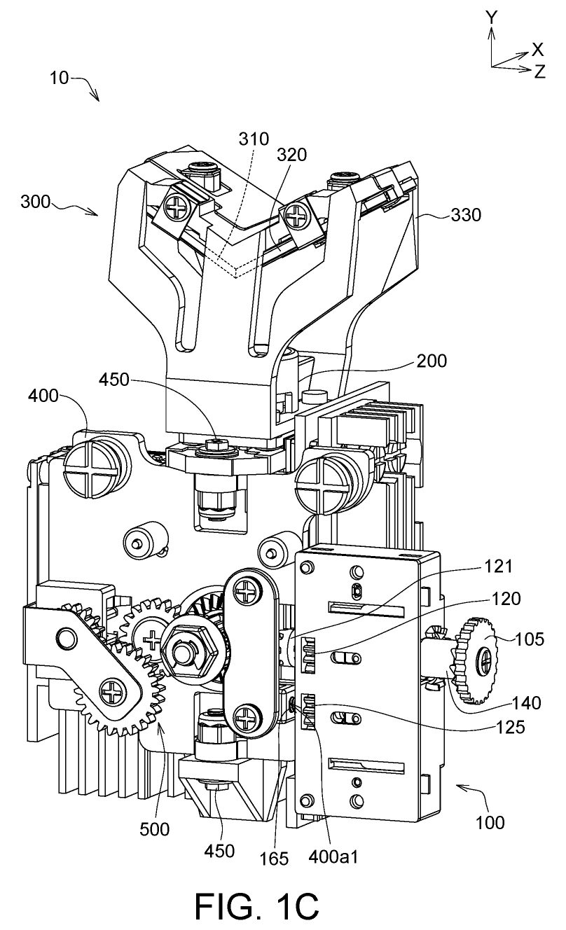

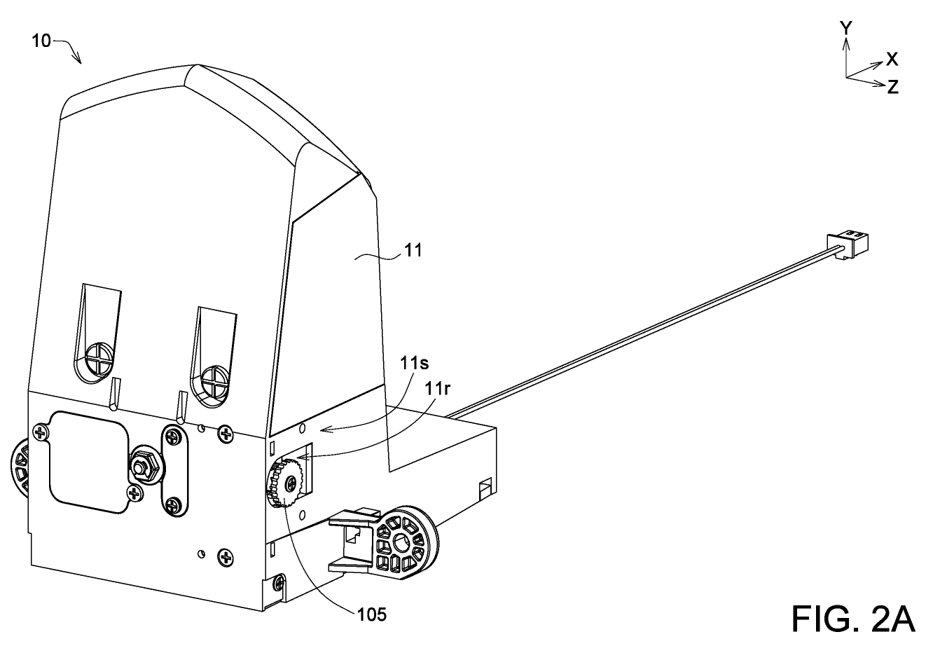

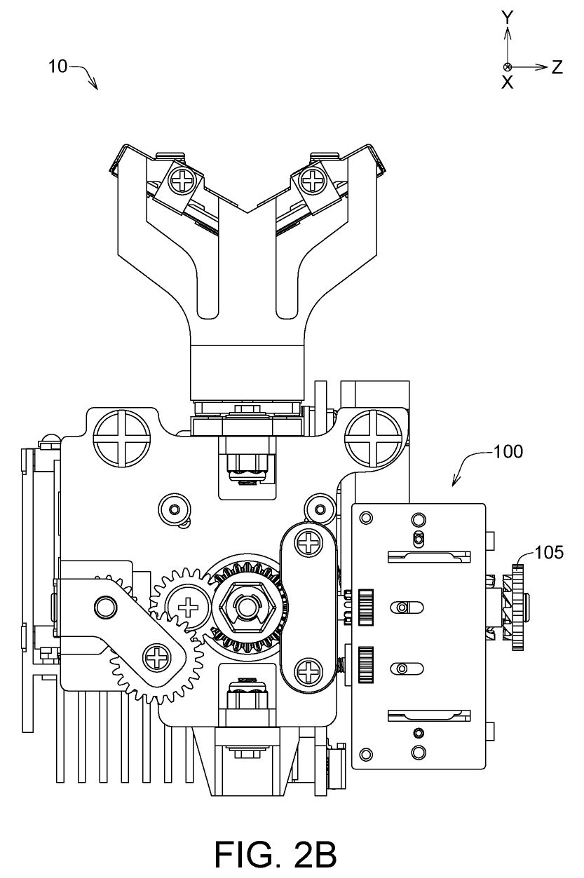

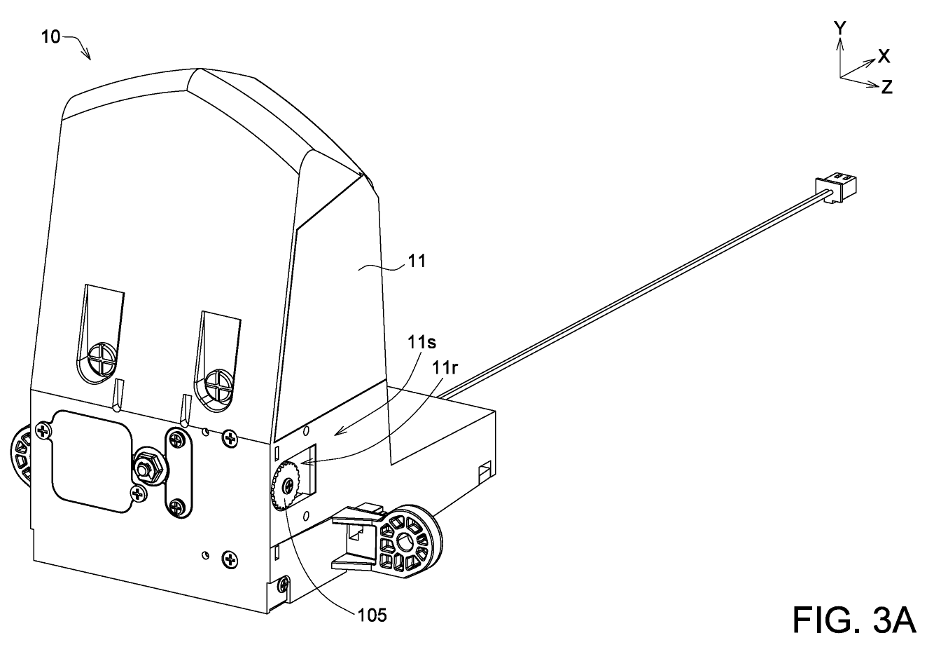

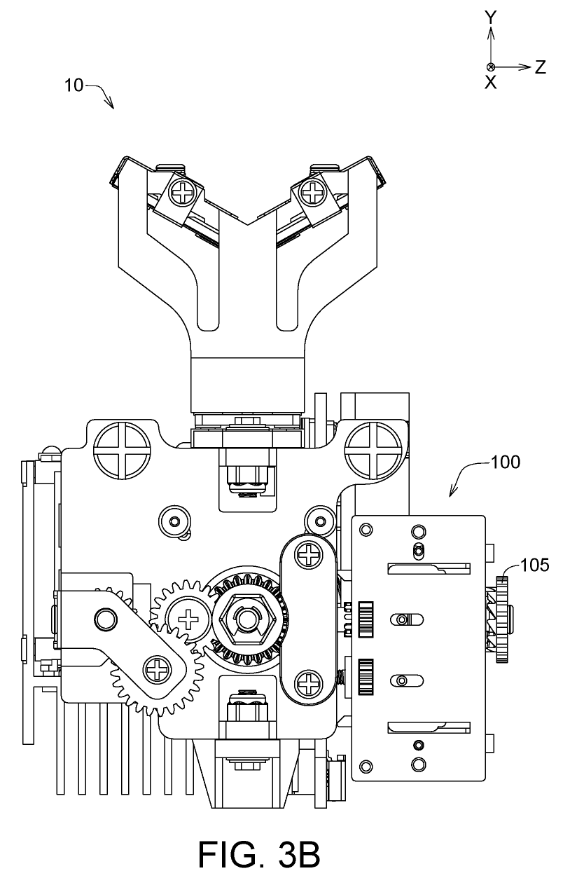

Referring to FIGS. 1A to 3B, FIG. 1A shows a schematic diagram (a first state) of a projector 10 according to an embodiment of the present invention, FIG. 1B shows a cross-sectional view of the projector 10 in FIG. 1A along a direction 1B-1B', FIG. 1C shows an internal schematic diagram of the projector 10 in FIG. 1A (a casing 11 is omitted), FIG. 2A shows a schematic diagram of the projector 10 in FIG. 1A in a second state, FIG. 2B shows an internal schematic diagram of the projector 10 in FIG. 2A (the casing 11 is omitted), FIG. 3A shows a schematic diagram of the projector 10 in FIG. 1A in a third state, and FIG. 3B shows an internal schematic diagram of the projector 10 in FIG. 3A (the casing 11 is omitted). The X-direction, the Y-direction and the Z-direction in the figures are perpendicular to each other.

As shown in FIGS. 1A to 1C, the projector 10 is disposed in a mobile carrier. The projector 10 includes an optical engine module 200 and an adjustment module 100. The adjustment module 100 is connected to the optical engine module 200 and includes a knob 105. When the knob 105 is in the first state, the optical engine module 200 is allowed to rotate about a first axis AX1. When the knob 105 is in the second state, the optical engine module 200 is allowed to rotate about a second axis AX2. The direction of the first axis AX1 and the direction of the second axis AX2 are different. In practice, based on the knob 105 being rotated in the first state, the optical engine module 200 rotates about the first axis AX1; based on the knob 105 being rotating in the second state, the optical engine module 200 rotates about the second axis AX2. As a result, by operating the same knob in different states, the optical engine module may be driven to rotate about different axes.

As shown in FIGS. 1A to 1C, the projector 10 includes the casing 11, the adjustment module 100, the optical engine module 200, a V-shaped reflector module 300, a carrier disk 400, a fixing element 450, a fixing shaft 470, a pivot element 480, a connection element 490 and a drive module 500.

As shown in FIGS. 1A to 1C, the projector 10 may be disposed in the mobile carrier, such as in a dashboard of the mobile carrier. For example, the casing 11 includes a first fixing portion 11A and a second fixing portion 11B, and the casing 11 is fixed to the mobile carrier by the first fixing portion 11A and the second fixing portion 11B. The projector 10 may project at least one image onto the dashboard. The mobile carrier is, for example, the mobile carrier including at least one wheel, such as a car, a bus or a truck. However, the mobile carrier may also be other type of the carrier, such as a ship or an airplane. The V-shaped reflector module 300 includes a first reflective mirror 310, a second reflective mirror 320, and a carrier element 330. The carrier element 330 is fixed to the optical engine module 200, and the first reflective mirror 310 and the second reflective mirror 320 are disposed on the carrier element 330 in a V-shape. The image projected by the optical engine module 200 is incident on the first reflective mirror 310 and the second reflective mirror 320, and then reflected by the first reflective mirror 310 and the second reflective mirror 320 to two areas of the dashboard, respectively.

As shown in FIGS. 1A to 1C, the V-shaped reflector module 300 is disposed relative to the optical engine module 200. The adjustment module 100 is connected to the optical engine module 200 and includes the knob 105. When the knob 105 is in the first state, the optical engine module 100 is allowed to rotate about the first axis AX1. When the knob 105 is in the second state, the optical engine module 200 is allowed to rotate about the second axis AX2. As a result, by operating the same knob 105 in different states, the optical engine module 200 may be driven to rotate around different axes.

As shown in FIG. 1A, a central axis of the knob 105 is defined as the third axis AX3, which is approximately parallel to the Z-direction. The aforementioned first axis AX1 is approximately parallel to the X-direction, while the second axis AX2 is approximately parallel to the Y-direction.

As shown in FIG. 1A, the casing 11 has an outer surface 11s and a groove 11r, wherein the groove 11r is recessed relative to the outer surface 11s. As shown in FIG. 1A, when the knob 105 is in the first state, the knob 105 protrudes relative to the outer surface 11s of the casing 11. As shown in FIGS. 1A and 2A, during a process of switching the knob 105 from the first state to the second state, the knob 105 moves toward the casing 11 along the third axis AX3, but the knob 105 still protrudes relative to the outer surface 11s of the casing 11. As shown in FIGS. 2A and 3A, during a process of switching the knob 105 from the second state to the third state, the knob 105 moves towards the casing 11 along the third axis AX3. When knob 105 is in the third state, the knob 105 is approximately flush with the outer surface 11s of the casing 11, or the knob 105 is retracted relative to the outer surface 11s of casing 11. The groove 11r and the knob 105 have a groove length L1 and a knob length L2 respectively in the same direction (for example, parallel to the X-direction), wherein the groove length L1 is greater than knob length L2. As a result, although the knob 105 does not protrude relative to the outer surface 11s of the casing 11, the user's fingers or tools may enter the groove 11r to drive the knob 105 to move away from the casing 11 along the third axis AX3. In an embodiment, the operation for the knob 105 may not be electrically driven but manually operated by the user.

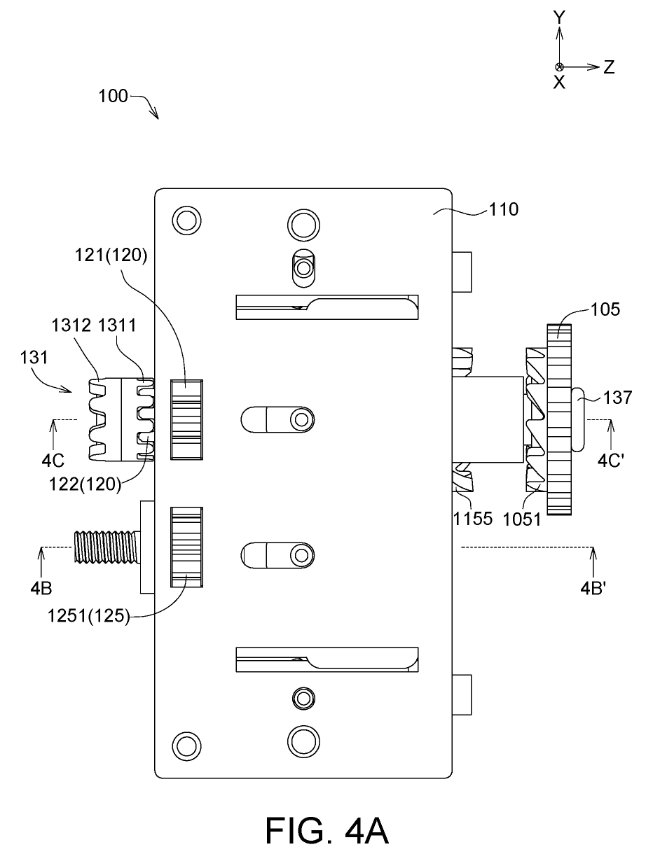

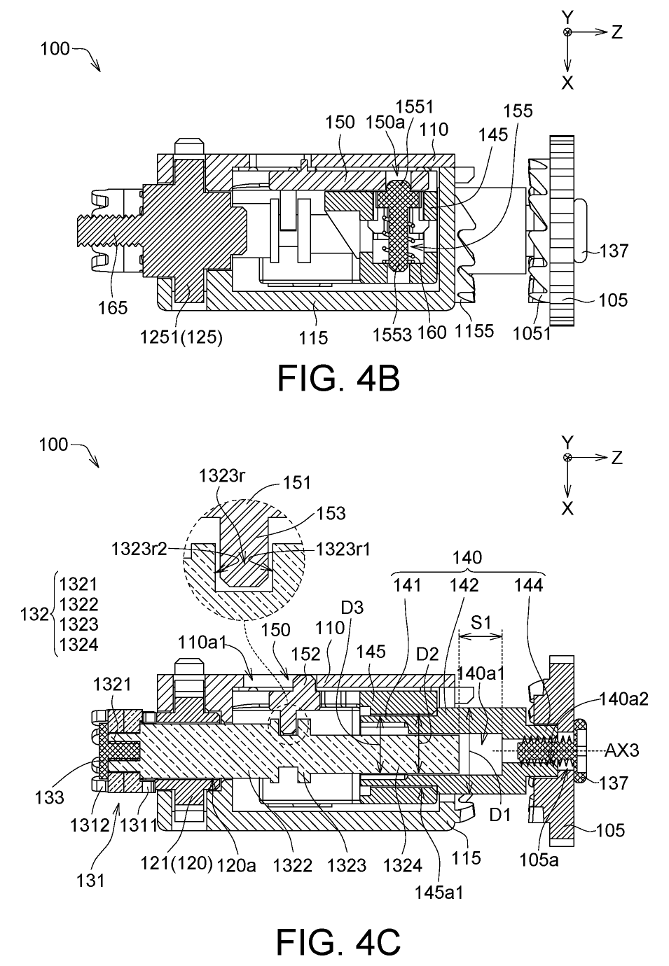

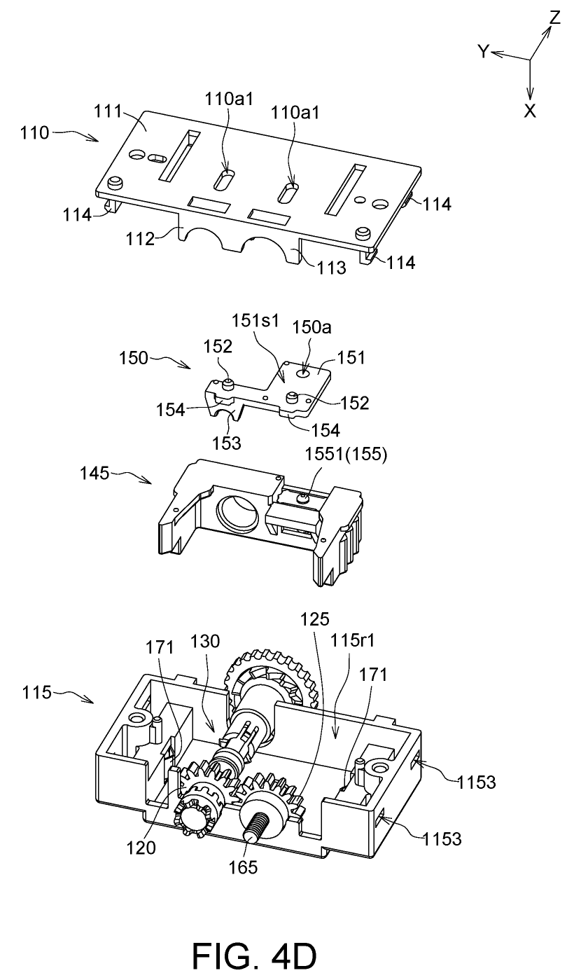

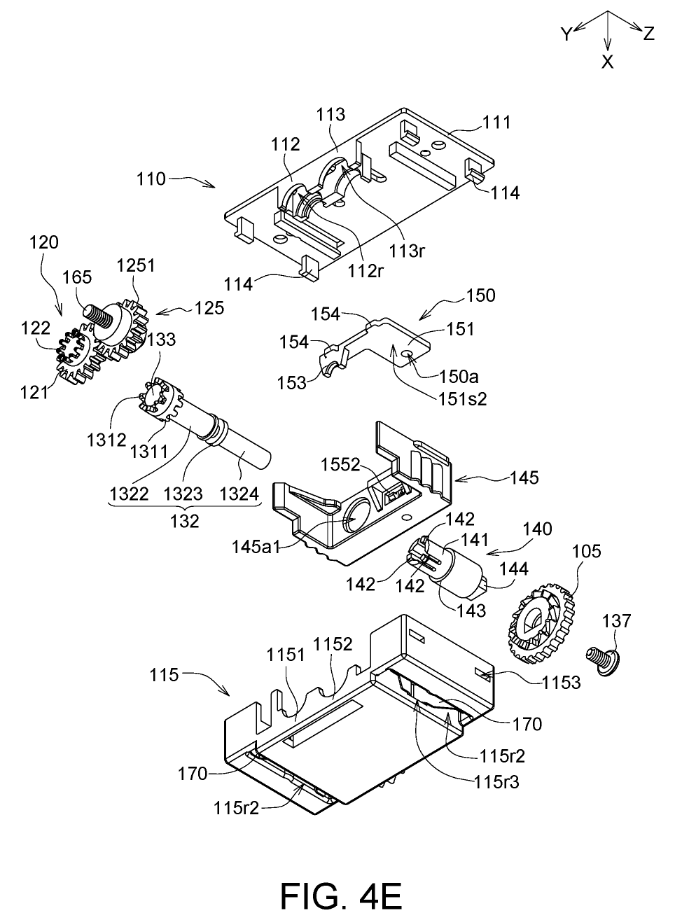

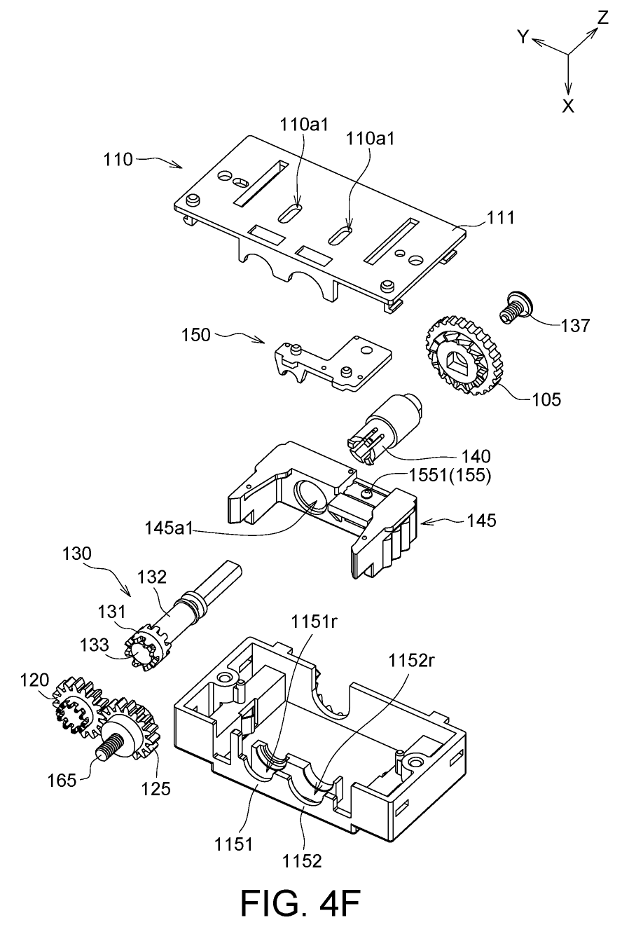

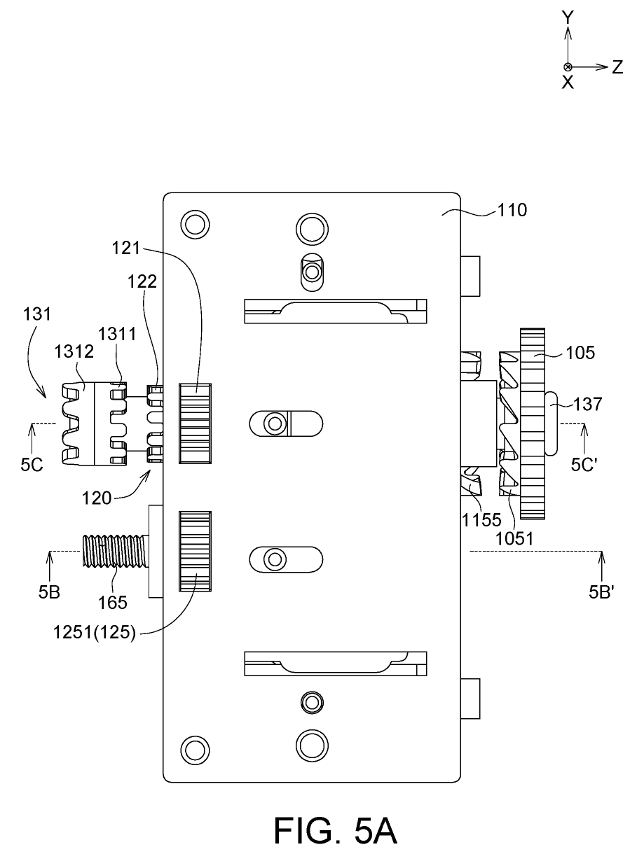

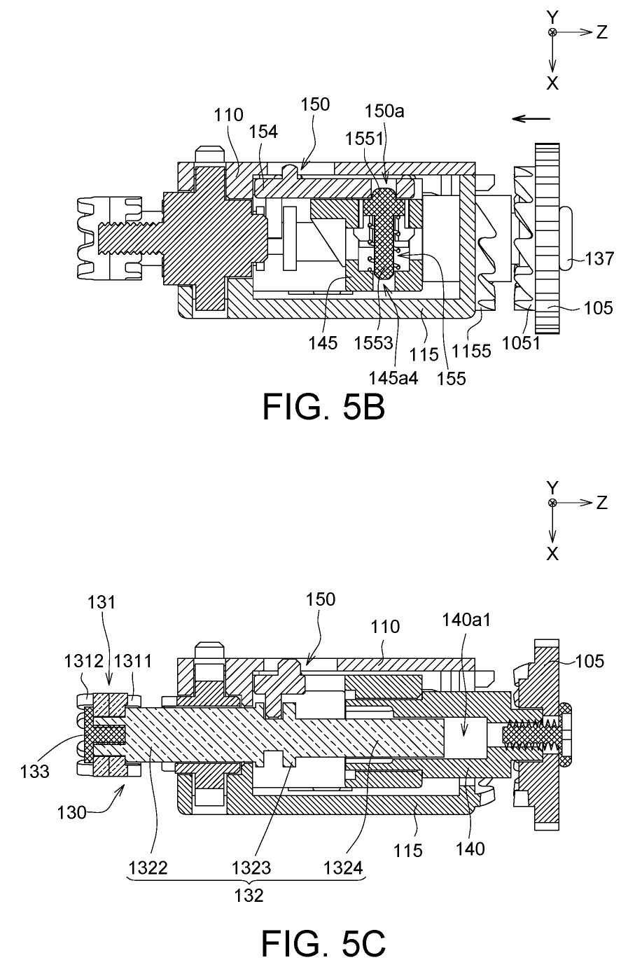

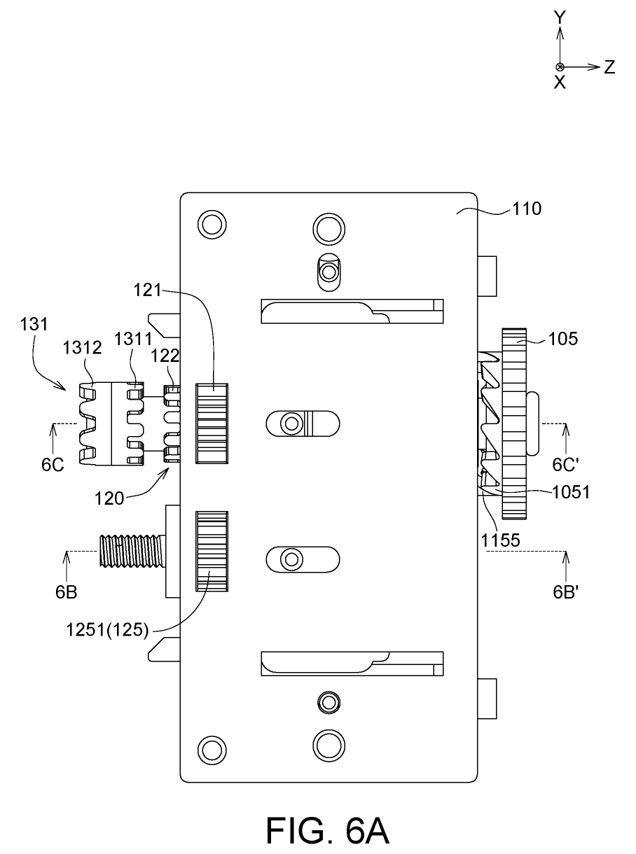

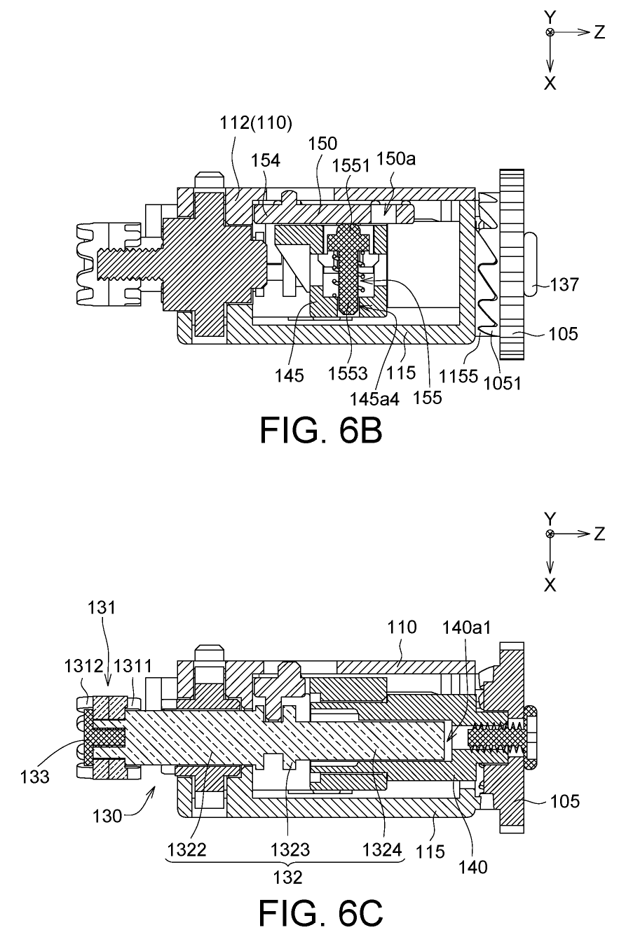

Referring to FIGS. 4A to 6C, FIG. 4A shows a schematic diagram of the adjustment module 100 in FIG. 1C (the first state), FIG. 4B shows a cross-sectional view of the adjustment module 100 in FIG. 4A along a direction 4B-4B', FIG. 4C shows a cross-sectional view of the adjustment module 100 in FIG. 4A along a direction 4C-4C', FIGS. 4D to 4F show exploded views of the adjustment module 100 in FIG. 4A from different perspectives, FIG. 5A shows the adjustment module 100 in FIG. 4A in the second state, FIG. 5B shows a cross-sectional view of the adjustment module 100 in FIG. 5A along a direction 5B-5B', FIG. 5C shows a cross-sectional view of the adjustment module 100 in FIG. 5A along a direction 5C-5C', FIG. 6A shows a schematic diagram of the adjustment module 100 in FIG. 5A in the third state, FIG. 6B shows a cross-sectional view of the adjustment module 100 in FIG. 6A along a direction 6B-6B', and FIG. 6C shows a cross-sectional view of the adjustment module 100 in FIG. 6A along a direction 6C-6C'.

As shown in FIGS. 4A to 4F, the adjustment module 100 further includes a first housing 110, a second housing 115, a first engagement element 120, a third engagement element 125, a clutch 130, a fixing element 137, a adapter 140, a sliding element 145, a sliding plate 150, a latch 155, an elastic element 160, a first threaded rod 165 and a spring piece 170.

As shown in FIGS. 4D and 4E, the first housing 110 includes a plate 111, a first limiting portion 112, and a second limiting portion 113. The first limiting portion 112 and the second limiting portion 113 are connected to the plate 111. The first limiting portion 112 has a first recess 112r, and the second limiting portion 113 has a second recess 113r. The first recess 112r may accommodate a portion of the first engagement element 120 to restrict the first engagement element 120, for example, restricting a displacement degrees of freedom (DoF) of the first engagement element 120 and the base plate 110 along the Z-direction. The second recess 113rmay accommodate a portion of the third engagement element 125 to restrict the third engagement element 125, for example, restricting the displacement DoF of the third engagement element 125 and the base plate 110 along the Z-direction.

As shown in FIGS. 4D and 4E, the second housing 115 includes a third limiting portion 1151 and a fourth limiting portion 1152. The third limiting portion 1151 has a third recess 1151r, and the fourth limiting portion 1152 has a fourth recess 1152r. The third recess 1151r may accommodate a portion of the first engagement element 120 to restrict the first engagement element 120, for example, restricting the displacement DoF of the first engagement element 120 and the base plate 110 along the Z-direction. The fourth recess 1152r may accommodate a portion of the third engagement element 125 to restrict the third engagement element 125, for example, restricting the displacement DoF of the third engagement element 125 and the base plate 110 along the Z-direction.

As shown in FIGS. 4D and 4E, the second housing 115 and the first housing 110 may be fixed to each other. For example, the first housing 110 further includes at least one first engagement portion 114, and the second housing 115 further includes at least one second engagement portion 1153. The first engagement portion 114 and the second engagement portion 1153 may be engaged with each other to fix the relative position of the first housing 110 and the second housing 115. One of the first engagement portion 114 and the second engagement portion 1153 is, for example, an engaging hook, while the other of the first engagement portion 114 and the second engagement portion 1153 is, for example, an engaging groove.

As shown in FIGS. 4D and 4E, the second housing 115 has a first receiving groove 115r1, at least one second receiving groove 115r2 and at least one through hole 115r3. The first receiving groove 115r1 may at least accommodate a portion of the clutch 130, the sliding element 145, the sliding plate 150, the latch 155 and the elastic element 160. The second receiving groove 115r2 may accommodate the spring piece 170. The through hole 115r3 connects the first receiving groove 115r1 with the second receiving groove 115r for allowing an end portion 171 of the spring piece 170 to enter the first receiving groove 115r1 through the through hole 115r3 for contacting the sliding element 145 located in the first receiving groove 115r1.

As shown in FIGS. 4D and 4E, the first engagement element 120 is rotatably disposed on the first housing 110 and the second housing 115. The first engagement element 120 and the third engagement element 125 are kept in an engaged state, so that the power of the clutch 130 may be transmitted to the third engagement element 125 through the first engagement element 120 when the clutch 130 is engaged with the first engagement element 120. The first engagement element 120 has a plurality of first engagement portions 121, and the third engagement element 125 has a plurality of third engagement portions 1251. The plurality of first engagement portions 121 of the first engagement element 120 and the plurality of third engagement portions 1251 of the third engagement element 125 are engaged. In an embodiment, the first engagement portions 121 and the third engagement portions 1251 may have teeth that are meshed with each other.

As shown in FIGS. 4D and 4E, the second engagement element 131 of the clutch 130 may selectively engage with the first engagement element 120. For example, when the knob 105 is in the first state, the second engagement element 131 engages with the first engagement element 120. As shown in FIG. 5A, when the knob 105 is in the second state, the second engagement element 131 disengages from the first engagement element 120. As shown in FIG. 6A, when the knob 105 is in the third state, the second engagement element 131 also disengages from the first engagement element 120. As shown in FIGS. 6A to 6B, when the knob 105 is in the third state, the knob 105 engages with the second housing 1151 to lock the knob 105. For example, as shown in FIG. 6A, the second housing 115 has a plurality of housing engagement portions 1155, and the knob 105 has a plurality of knob engagement portions 1051. When the knob 105 is in the third state, the housing engagement portions 1155 and the knob engagement portions 1051 engage with each other, it may restrict the relative rotational DoF of the knob 105 and the second housing 115. In an embodiment, the housing engagement portions 1155 and the knob engagement portions 1051 are, for example, meshed teeth. In summary, the third state is a locked state of the knob 105.

As shown in FIGS. 4A and 4E, the second engagement element 131 of the clutch 130 has a plurality of second engagement portions 1311, and the first engagement element 120 further includes a plurality of fourth engagement portions 122. The fourth engagement portions 122 of the second engagement element 131 may selectively engage with the second engagement portions 1311 of the clutch 130. As shown in FIG. 4A, when the knob 105 is in the first state, the fourth engagement portions 122 of the second engagement element 131 engage with the second engagement portions 1311 of the clutch 130. As a result, when the clutch 130 rotates about a third axis AX3, the clutch 130 may drive the first engagement element 120 to rotate for driving the third engagement element 125 to rotate synchronously. As shown in FIG. 5A, when the knob 105 is in the second state, the fourth engagement portions 122 of the second engagement element 131 disengage from the second engagement portions 1311 of the clutch 130. As a result, when the clutch 130 rotates about the third axis AX3, the clutch 130 cannot drive the first engagement element 120 and the third engagement element 125 to rotate. As shown in FIG. 6A, when the knob 105 is in the third state, the fourth engagement portions 122 of the second engagement element 131 disengages from the second engagement portions 1311 of the clutch 130. In an embodiment, the fourth engagement portions 122 and the second engagement portions 1311 are, for example, meshed gear teeth. Furthermore, the second engagement element 131 of the clutch 130 further includes a plurality of fifth engagement portions 1312, wherein the fifth engagement portions 1312 are, for example, gear teeth, and may selectively engage with the drive module 500, as described later.

In the present embodiment, the aforementioned first engagement element 120, second engagement element 131 and third engagement element 125 are, for example, gear structures, but this is not a limitation of the embodiments of the present invention.

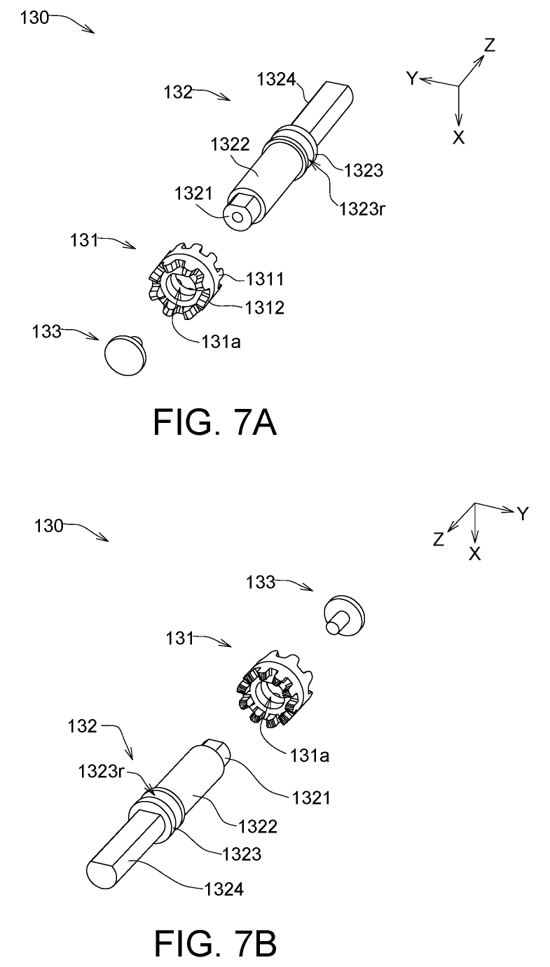

Referring to FIGS. 7A to 7B, FIGS. 7A to 7B show exploded views of the clutch 130 in FIG. 6A from different perspectives.

As shown in FIGS. 7A to 7B, the clutch 130 is connected to the knob 105, slidably configured relative to the first housing 110 and includes the aforementioned second engagement element 131. The clutch 130 includes a clutch shaft 132 and a fixing element 133. The clutch 130 may be considered a one-piece structure, that is, there is no relative movement among the aforementioned second engagement element 131, the aforementioned clutch shaft 132 and the aforementioned fixing element 133. The clutch shaft 132 includes an engagement end 1321, a first shaft body 1322, a limiting portion 1323 and a second shaft body 1324. The first shaft body 1322 connects the engagement end 1321 with the limiting portion 1323, while the limiting portion 1323 connects the first shaft body 1322 with the second shaft body 1324.

As shown in FIGS. 7A to 7B, the second engagement element 131 has a through hole 131a, and the engagement end 1321 of the clutch shaft 132 engages with the through hole 131a of the second engagement element 131. In the present embodiment, the through hole 131a and the engagement end 1321 may be designed in shapes other than circular, such as D-shaped. The engagement end 1321 and the through hole 131a respectively have a major diameter and a minor diameter in two different directions, so that the clutch shaft 132 and the second engagement element 131 will not rotate relative to each other after the through hole 131a and the engagement end 1321 are engaged. As a result, when the clutch shaft 132 rotates around the third axis AX3, it may drive the second engagement element 131 to rotate synchronously around the third axis AX3. In addition, the fixing element 133 may press against the second engagement element 131 and is fixed to the fixing hole 1321a of the engagement end 1321 for fixing the relative position of the clutch shaft 132 and the second engagement element 131. In the present embodiment, the fixing element 133 has, for example, a male thread, and the fixing hole 1321a has, for example, a female thread that mates with the male thread.

As shown in FIGS. 4C and 7A to 7B, the clutch shaft 132 and the first engagement element 120 may slide relative to each other. For example, the first shaft 1322 of the clutch shaft 132 is loosely fitted with the through hole 120a (the through hole 120a is shown in FIG. 4C) of the first engagement element 120. As a result, the clutch 130 may slide relative to the first engagement element 120 along the third axis AX3 (the third axis AX3 is shown in FIG. 4C). As a result, the movement of the clutch 130 along the third axis AX3 is not restricted by the first engagement element 120 (since the first engagement element 120 is restricted between the first housing 110 and the second housing 115, the first engagement element 120 cannot move along the third axis AX3).

As shown in FIG. 4C and 7A to 7B, the limiting portion 1323 of the clutch shaft 132 may be coupled to the sliding plate 150, and accordingly the limiting portion 1323 and the sliding plate 150 move synchronously. For example, the limiting portion 1323 has a groove 1323r, and the limiting portion 153 of the sliding plate 150 may be located within the groove 1323r. As a result, when the clutch 130 slides along the third axis AX3, the sliding plate 150 may move synchronously along the Z-direction. The groove 1323r of the limiting portion 1323 has a first limiting lateral surface 1323r1 and a second limiting lateral surface 1323r2 opposite to the first limiting lateral surface 1323r1. The limiting portion 153 of the sliding plate 150 may be located between the first limiting lateral surface 1323r1 and the second limiting lateral surface 1323r2, so that the limiting portion 153 of the sliding plate 150 is restricted between the first limiting lateral surface 1323r1 and the second limiting lateral surface 1323r2. In addition, the limiting portion 153 of the sliding plate 150 and the groove 1323r of the limiting portion 1323 of the clutch shaft 132 may be, for example, in a transition fit or a loose fit, so that the clutch 130 and the sliding plate 150 rotate relative to each other around the third axis AX3; that is, the sliding plate 150 does not affect the rotation of the clutch 130. In an embodiment, the groove 1323r is, for example, a full-circumference (i.e., 360-degree) groove. As a result, the clutch 130 and the sliding plate 150 may rotate relative to each other by 360 degrees.

As shown in FIGS. 4C and 7A to 7B, the second shaft 1324 of the clutch shaft 132 of the clutch 130 is connected to the adapter 140 in a non-rotatable manner. For example, the second shaft 1324 and the through hole 140a1 of the adapter 140 is designed in a shape other than a circle, such as a D-shape. The second shaft 1324 and the through hole 140a1 respectively have a major diameter and a minor diameter in two different directions, so that the clutch shaft 132 and the adapter 140 will not rotate relative to each other when the second shaft 1324 and the through hole 140a1 are engaged. As a result, when the adapter 140 rotates about the third axis AX3, it may drive the clutch 130 to rotate synchronously about the third axis AX3. In addition, the second shaft 1324 of the clutch shaft 132 is slidably connected to the adapter 140. For example, the through hole 140a1 of the second shaft 1324 and the adapter 140 are in a transition fit or a loose fit, so that the clutch 130 and the adapter 140 slide relative to each other. As shown in FIG. 4C, when the knob 105 is in the first state, there is a space between the end portion of the second shaft 1324 and a lateral wall of the through hole 140a1, which provides a sliding stroke S1 for the clutch 130 and the adapter 140 sliding relative to each other. As a result, as shown in FIGS. 5C and 6C, when the knob 105 switches from the second state (FIG. 5C) to the third state (FIG. 6C), the adapter 140 may still continue to move relative to the clutch 130 in the -Z-direction although the clutch 130 may no longer move in the -Z-direction (described in detail later).

As shown in FIG. 4C, the fixing element 137 passes through the through hole 105a of the knob 105 and is fixed in the fixing hole 140a2 of the adapter 140 for fixing the relative position between the knob 105 and the adapter 140. As a result, when the knob 105 rotates about the third axis AX3, it may drive the adapter 140 and the clutch 130 to rotate synchronously about the third axis AX3. In an embodiment, the fixing element 137 has, for example, a male thread, and the fixing hole 140a2 has, for example, a female thread that mates with the male thread.

As shown in FIGS. 4C, 4E, and 4F, the adapter 140 and the sliding element 145 are connected in a way that allows relative rotation but not relative sliding. The adapter 140 includes a body 141, a first limiting portion 142, a second limiting portion 143 and a fixing end 144. The body 141 passes through the through hole 145a1 of the sliding element 145. The second limiting portion 143 connects the body 141 with the fixing end 144. The fixed end 144 has the aforementioned fixed hole 140a2. The first limiting portion 142 is connected to the body 141, for example, to the end portion of the body 141. The first limiting portion 142 and the second limiting portion 143 respectively abut against the opposite sides of the sliding element 145 for restricting the relative displacement DoF of the adapter 140 and the sliding element 145 along the third axis AX3. As a result, when the adapter 140 moves along the third axis AX3, the adapter 140 may drive the sliding element 145 to move synchronously in the Z-direction. In the present embodiment, the first limiting portion 142 is, for example, an engagement hook, wherein the engagement hook prevents the adapter 140 from disengaging from the sliding element 145 in the +Z-direction, while an outer diameter D1 of the second limiting portion 143 is greater than an inner diameter D2 of the through hole 145a1 of the body 141, and it may prevent the adapter 140 from disengaging from the sliding element 145 in the -Z-direction. As shown in FIG. 4C, the body 141 of the adapter 140 and the through hole 145a1 of the sliding element 145 are in, for example, a transition fit or a loose fit. For example, an outer diameter D3 of the body 141 is smaller than the inner diameter D2 of the through hole 145a1, so that the adapter 140 and the sliding element 145 rotate relative to each other.

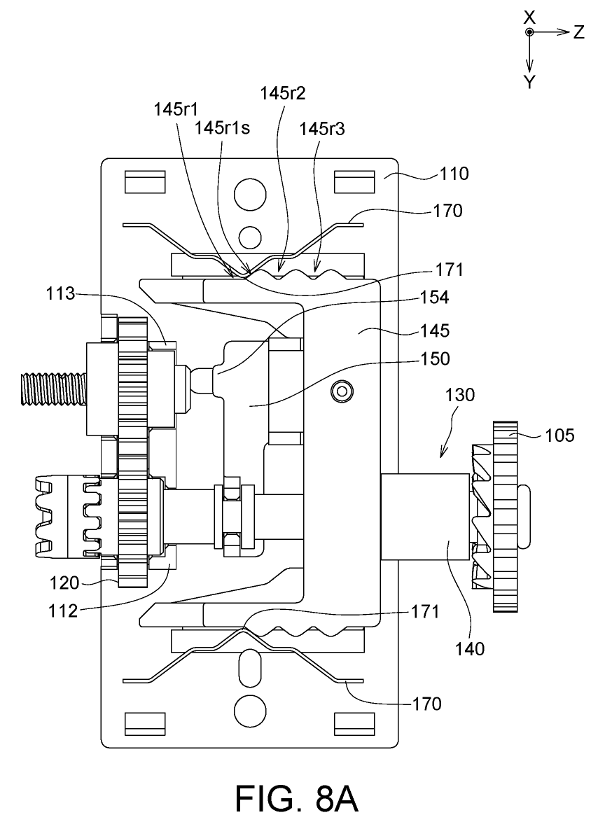

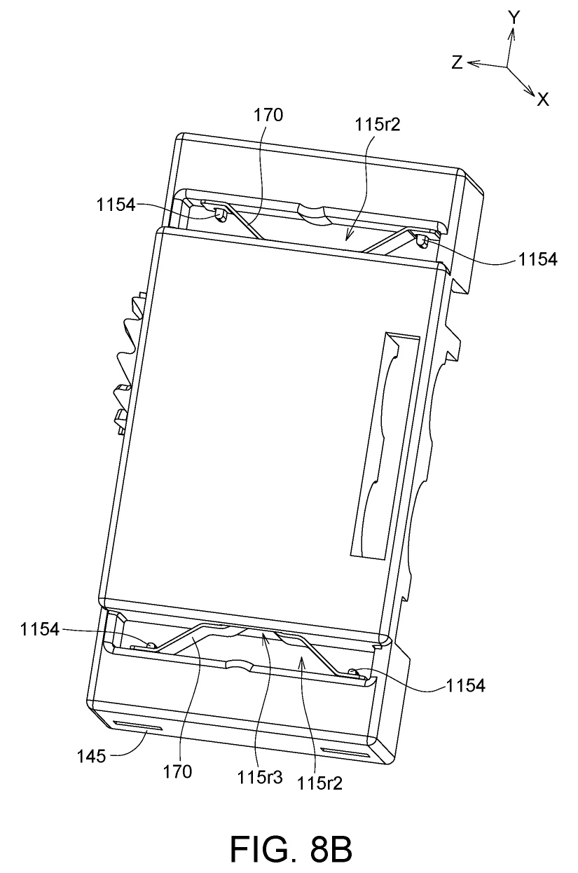

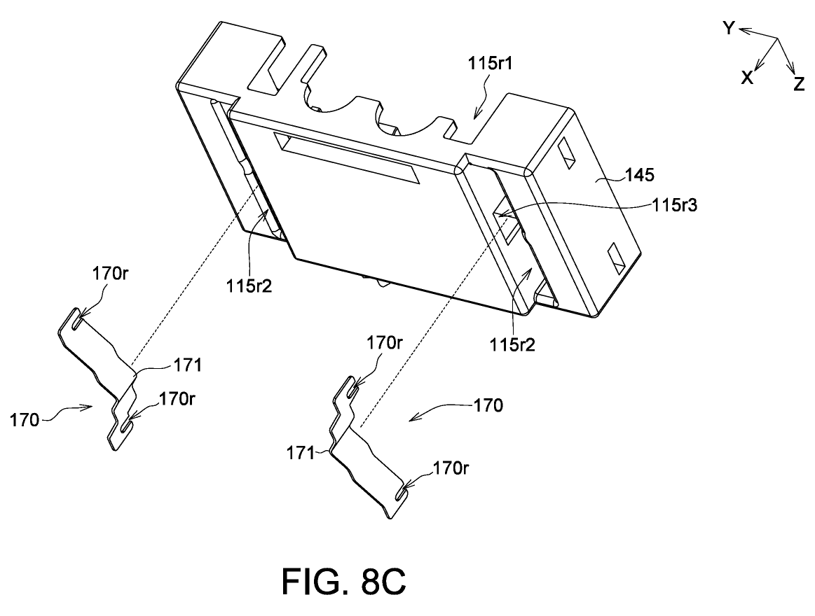

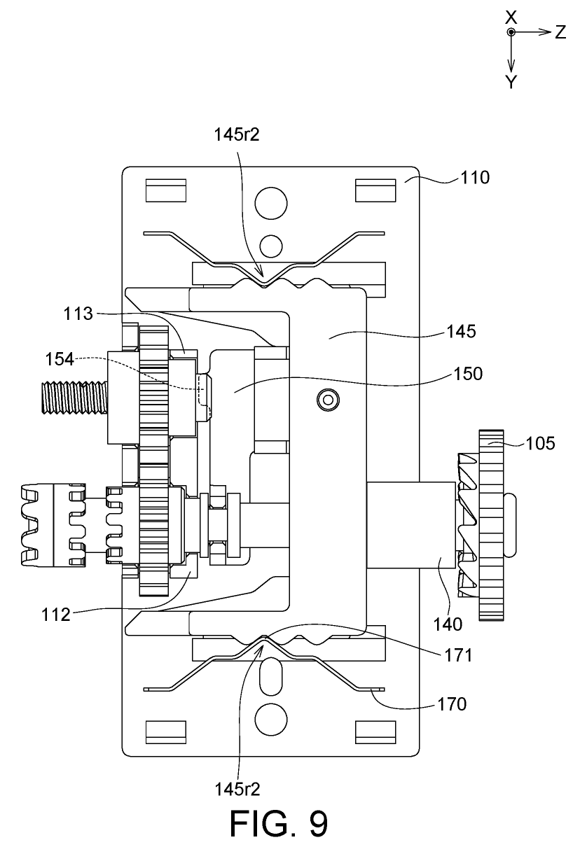

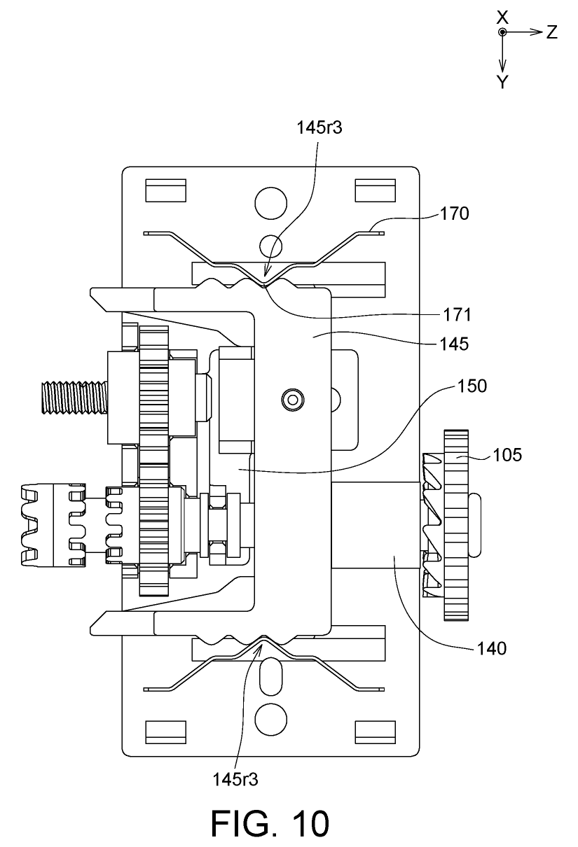

Referring to FIGS. 8A to 10, FIG. 8A shows an assembly diagram (the first state) of the clutch 130, the first housing 110, the sliding element 145, the sliding plate 150 and the spring piece 170 in FIG. 4D, FIG. 8B shows an assembly diagram of the sliding element 145 and the spring piece 170 in FIG. 8A, FIG. 8C shows an exploded view of the sliding element 145 and the spring piece 170 in FIG. 8B, FIG. 9 shows a schematic diagram of the knob 105 of FIG. 8A in the second state, and FIG. 10 shows a schematic diagram of the knob 105 in FIG. 9 in the third state.

As shown in FIGS. 8A to 8C, the sliding element 145 has a first recess 145r1, a second recess 145r2 and a third recess 145r3. When the sliding element 145 moves along the Z-direction, one of the first recess 145r1, the second recess 145r2 and the third recess 145r3 may engage with the spring piece 170. For example, as shown in FIG. 8A, when the knob 105 is in the first state, the end portion 171 of the spring piece 170 is located in the first recess 145r1. As shown in FIG. 9, when the knob 105 is in the second state, the end portion 171 of the spring piece 170 is located in the second recess 145r2. As shown in FIG. 10, when the knob 105 is in the third state, the end portion 171 of the spring piece 170 is located in the third recess 145r3. Through the temporary engagement design of the multiple recesses and the spring piece 170, a segmented switching feel may be generated when the sliding element 145 moves along the Z-direction.

As shown in FIG. 8A, the first recess 145r1 has a sidewall 145r1s that overlaps with the end portion 171 in the Z-direction, and the sidewall 145r1s is closer to the knob 105 in the +Z-direction than the end portion 171. The end portion 171 may stop the sidewall 145r1s of the sliding element 145 from moving in the -Z-direction. Unless an external force is applied to overcome the elasticity of the spring piece 170, the spring piece 170 may stop the sliding element 145 from moving in the -Z-direction. In addition, due to the stop of the first engagement element 120, the clutch 130 cannot move in the +Z-direction. As shown in FIGS. 8A and 9, during a process of switching the knob 105 from the first state to the second state, the sliding element 145 overcomes the elasticity of the spring piece 170 (for example, by applying an external force) and moves relative to the spring piece 170 in the -Z-direction. Similarly, as shown in FIGS. 9 and 10, during a process of switching the knob 105 from the second state to the third state, the sliding element 145 overcomes the elastic force of spring piece 170 (for example, by applying the external force) and moves relative to spring piece 170 in the -Z-direction.

As shown in FIGS. 8A and 9, during a switching process from the first state to the second state, the knob 105 moves in the -Z-direction to drive adapter 140, the sliding element 145 and the sliding plate 150 to move synchronously in the -Z-direction. In the second state, as shown in FIG. 9, the sliding plate 150 is stopped by a limiting portion (for example, the first limiting portion 112 and/or the second limiting portion 113) of the first housing 110, and accordingly the the sliding plate 150 cannot move in the -Z-direction. As shown in FIGS. 9 and 10, during a switching process from the second state to the third state, the knob 105 moves along the -Z-direction to drive the adapter 140 and the sliding element 145 to move synchronously along the -Z-direction. However, the sliding plate 150 does not move synchronously and remains in the position in the second state (as shown in FIG. 9).

As shown in FIGS. 4D and 4E, the sliding plate 150 and the first housing 110 may slide relative to each other. For example, the plate 111 of the first housing 110 has at least one sliding slot 110a1. The sliding plate 150 includes a plate 151, at least one sliding block 152, the aforementioned limiting portion 153 and at least one block 154. The plate 151 has a first surface 151s1 and a second surface 151s2 opposite to the first surface 151s1. The sliding block 152 is disposed on the first surface 151s1 of the plate 151 and protrudes relative to the first surface 151s1. When the first housing 110 and the sliding plate 150 are combined, the sliding block 152 is slidably engaged with the sliding slot 110a1. In an embodiment, the sliding slot 110a1 extends, for example, along the Z-direction, so that the sliding plate 150 and the first housing 110 slide relative to each other along the Z-direction. The block 154 is connected to a lateral surface of the plate 151.

As shown in FIG. 9, when the knob 105 is in the second state, the block 154 abuts against a limiting portion of the first housing 110 (for example, the first limiting portion 112 and/or the second limiting portion 113). As a result, during a process of switching the knob 105 from the second state (FIG. 9) to the third state (FIG. 10), the sliding plate 150 cannot move in the -Z-direction due to the stop of the limiting portion of the first housing 110.

During a process of switching the knob 105 from the first state to the second state, the sliding element 145 and the sliding plate 150 are non-slidingly connected. During a process of switching the knob 105 from the second state to the third state, the sliding element 145 and the sliding plate 150 are slidably connected, as further illustrated below.

As shown in FIGS. 4B, 5B, and 6B, the sliding plate 150 has a recessed hole 150a, and the recessed hole 150a passes through the plate body 151 (the plate body 151 is shown in FIG. 4D). The latch 155 is disposed on the sliding element 145. The latch 155 and the sliding element 145 are non-slidably connected in the Z-direction but slidably connected in the X-direction. For example, the latch 155 has a limiting end 1551. The limiting end 1551 of the latch 155 may be located within the recessed hole 150a of the sliding plate 150, so that the sliding element 145 and the sliding plate 150 move synchronously. For example, the limiting end 1551 drives the sliding plate 150 to move in the Z-direction. As a result, as shown in FIGS. 4B and 5B, during a process of switching the knob 105 from the first state to the second state, the sliding element 145 and the sliding plate 150 move synchronously in the -Z-direction. As shown in FIGS. 5B and 6B, during a process of switching the knob 105 from the second state to the third state, the sliding plate 150 remains stationary relative to the first housing 110. After the sliding element 145 continues to move relative to sliding plate 150 in the -Z-direction, the limiting end 1551 of the latch 155 is forced to move in the +X-direction and disengage from the recessed hole 150a. In addition, as shown in FIGS. 5C and 6C, due to the adapter 140 and the clutch 130 being slidably connected in the -Z-direction, the knob 105 may continue to move in the -Z-direction during the a process of switching the knob 105 from the second state (FIG. 5C) to the third state (FIG. 6C).

As shown in FIGS. 5C and 6C, during a process of switching the knob 105 from the second state to the third state, due to the sliding plate 150 being stopped by the first housing 110, the clutch 130 also cannot move in the -Z-direction (the clutch 130 and the sliding plate 150 do not slide relative to each other in the Z-direction). As a result, the second engagement element 131 of the clutch 130 may be held in the position of the second state (as shown in FIG. 5C), and in this position, the second engagement element 131 engages with the drive module 500. Furthermore, since the clutch 130 (or the sliding plate 150) and the knob 105 may slide relative to each other in the -Z-direction in the second state, during a process of switching the knob 105 from the second state to the third state, the second engagement element 131 of the clutch 130 may be held in the position of the second state, while the knob 105 may continue to move in the -Z-direction to the position of the third state (if the clutch 130 and the knob 105 cannot slide relative to each other, the second engagement element 131 abuts against the drive module 500 to prevent the knob 105 from continuing to move in the -Z-direction to the position of the third state). In the second state, the second engagement element 131 of the clutch 130 engages with the drive module 500, so that the clutch 130 drives the optical engine module 200 to rotate around the second axis AX2, as described later.

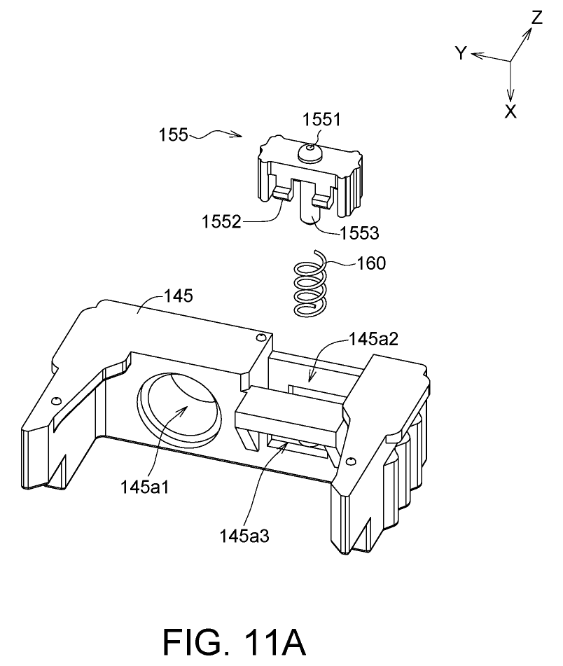

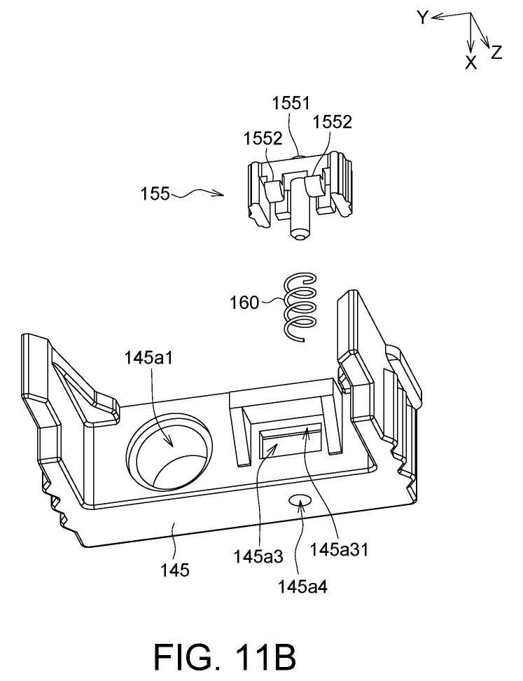

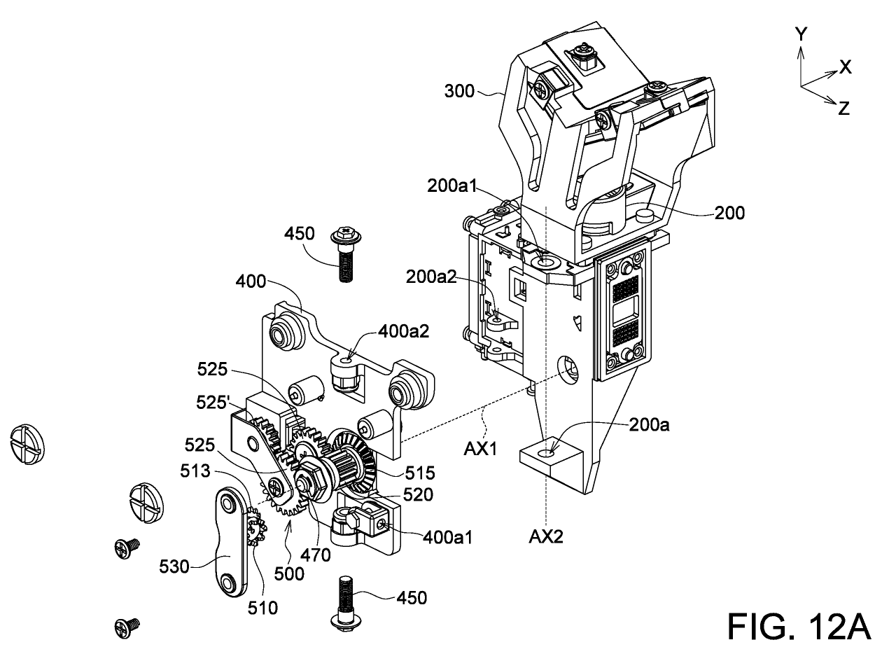

As shown in FIGS. 4C and 11A to 11B, FIGS. 11A to 11B show exploded views of the sliding element 145, the elastic element 160 and the latch 155 in FIG. 4D from different perspectives. The sliding element 145, the elastic element 160 and the latch 155 may form a sliding module. The sliding element 145 further has a receiving hole 145a2 and a limiting hole 145a3, wherein the receiving hole 145a2 and the limiting hole 145a3 communicate with each other. The latch 155 is slidably disposed in the receiving hole 145a2 along the X-direction. The elastic element 160 is disposed within the receiving hole 145a2 and is located between the latch 155 and the sliding element 145. As a result, as shown in FIG. 6B, when the latch 155 moves away from the recessed hole 150a, the elastic element 160 deforms (for example, compresses) and stores elastic potential energy. When the elastic element 160 is released, the elastic element 160 releases its elastic potential energy to drive the limiting end 1551 into the recessed hole 150a, as shown in FIG. 5B.

As shown in FIG. 11A to 11B, the latch 155 further includes at least one limiting portion 1552, wherein the limiting portion 1552 is slidably located in the limiting hole 145a3 of the sliding element 145. The limiting portion 1552 abuts against a sidewall 145a31 of the limiting hole 145a3 to prevent the latch 155 from disengaging from the sliding element 145 in the -X-direction. Furthermore, although the elastic element 160 applies a preload to the latch 155 in the -X-direction, the latch 155 cannot disengage from the sliding element 145 in the -X-direction since the limiting portion 1552 abuts against the sidewall 145a31 of the limiting hole 145a3.

As shown in FIGS. 11A to 11B, the latch 155 further includes an end portion 1553, and the sliding element 145 also has a receiving hole 145a4. The end portion 1553 overlaps with the receiving hole 145a4 in the X-direction. As a result, as shown in FIGS. 5B and 6B, when the knob 105 is in the second state (FIG. 5B) and the third state (FIG. 6B), the end portion 1553 and the receiving hole 145a4 may be located within the receiving hole 145a4 to prevent an interference between the latch 155 and the sliding element 145.

As shown in FIG. 4D, the first threaded rod 165 and the third engagement element 125 are connected to each other. For example, the first threaded rod 165 and the third engagement element 125 may be fixedly connected to each other. As a result, the third engagement element 125 and the first threaded rod 165 may rotate synchronously. In an embodiment, the first threaded rod 165 and the third engagement element 125 are, for example, an integrally formed structure. In terms of material, the first threaded rod 165 and the third engagement element 125 may be made of plastic. In terms of manufacturing process, the first threaded rod 165 and the third engagement element 125 may be integrally formed by, for example, using injection molding technology. In addition, the first threaded rod 165 may be connected to a carrier disk 400 (the carrier disk 400 is shown in FIG. 1C) to drive the carrier disk 400 to rotate about a first axis AX1, and it will be explained later.

As shown in FIG. 8A to 8C, the spring piece 170 has an end portion 171, wherein the spring piece 170 enters the first receiving groove 115r1 through a through hole 115r3 of the second housing 115 to engage with one of the first recess 145r1, the second recess 145r2 and the third recess 145r3 of the sliding element 145. The spring piece 170 has a limiting groove 170r, and the second housing 115 includes at least one limiting post 1154 disposed on a groove sidewall of the second receiving groove 115r2 of the second housing 115. When the spring piece 170 is located in the second receiving groove 115r2, the limiting post 1154 engages with the limiting groove 170r, it may restrict the relative displacement DoF between the spring piece 170 and the second housing 115. In the present embodiment, the limiting groove 170r may extend along the X-direction, so that the relative displacement DoF between the spring piece 170 and the second housing 115 along the Y-direction may be restrained when the limiting post 1154 is engaged with the limiting groove 170r. The limiting post 1154 and the limiting groove 170r form a fixed point. When the spring piece 170 is subjected to an external force (for example, the sliding element 145 presses the spring piece 170), due to the support of the fixed point, the spring piece 170 may deform relative to the fixed point (for example, deform in the Y-direction), and accordingly it causes the end portion 171 of the spring piece 170 to retract inward toward the second receiving groove 115r2. In addition, when the end portion 171 of the spring piece 170 is located in the recess of the sliding element 145 (for example, one of the first recess 145r1, the second recess 145r2 and the third recess 145r3), the spring piece 170 still has a pre-deformation amount. Therefore, the spring piece 170 may apply an elastic abutment force to the sidewall of the second receiving groove 115r2, so that it is difficult for the spring piece 170 to disengage from the second receiving groove 115r2.

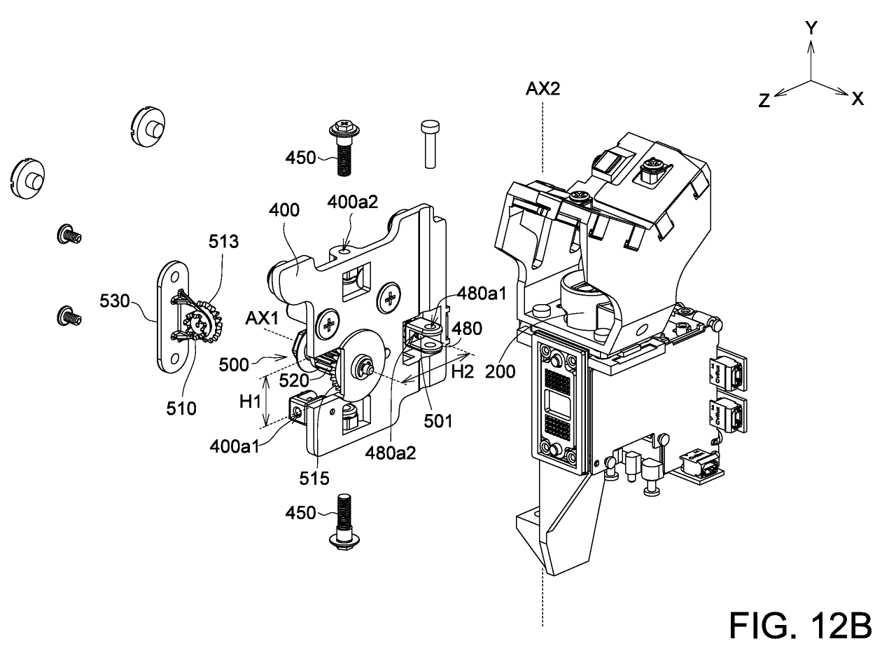

Referring to FIGS. 1B to 1C and 12A to 12B, FIGS. 12A and 12B show exploded views of the V-shaped reflector module 300, the carrier disk 400, at least one fixing element 450, the fixing shaft 470 and the drive module 500 in FIG. 1C from two different perspectives.

As shown in FIGS. 1B to 1C and 12A to 12B, the carrier disk 400 is connected to the optical engine module 200 and has a first screw hole 400a1. A first threaded rod 165 is screwed into the first screw hole 400a1. In the present embodiment, regardless of whether it is the first state, the second state or the third state, the first threaded rod 165 and the first screw hole 400a1 remain screwed. The first screw hole 400a1 extends along the Z-direction, and the first screw hole 400a1 is spaced from the first axis AX1 along the Y-direction by a distance H1, so that the carrier disk 400 and the optical engine module 200 rotate synchronously (since the fixing element 450 connects the carrier disk 400 and the optical engine module 200, the carrier disk 400 and the optical engine module 200 may rotate synchronously) around the first axis AX1 when the first threaded rod 165 rotates around the +/-Z-direction. In an embodiment, when the first threaded rod 165 rotates around the -Z-direction, the optical engine module 200 may rotate around the first axis AX1 in a first direction (for example, one of the +X-direction and the -X-direction). When the first threaded rod 165 rotates around the +Z-direction, the optical engine module 200 may rotate around the first axis AX1 in a second direction (for example, the other of the +X-direction and the -X-direction). When the knob 105 is in the first state, for each revolution of the knob 105, the optical engine module 200 may rotate around the first axis AX1 by a first predetermined angle. The first predetermined angle depends on the thread design (for example, lead) and the distance H1 of the first threaded rod 165, and is not limited to the present embodiment. In an embodiment, the first predetermined angle is, for example, 0.5 degrees.

As shown in FIGS. 1B to 1C and 12A to 12B, the fixing shaft 470 may be fixed to the carrier disk 400. For example, the fixing shaft 470 is screwed into the carrier disk 400. The first axis AX1 in the present embodiment coincides with a central axis of the fixing shaft 470, or the central axis of the fixing shaft 470 defines the first axis AX1. Furthermore, as shown in FIG. 1B, the fixing shaft 470 passes through the through hole 11a of the casing 11, with a gap between the through hole 11a and the fixing shaft 470. As a result, when the fixing shaft 470 rotates about the first axis AX1 (for example, the carrier disk 400 drives the fixing shaft 470 to rotate about the first axis AX1), the casing 11 and the fixing shaft 470 do not interfere with each other.

As shown in FIGS. 1B to 1C and 12A to 12B, the carrier disk 400 and the optical engine module 200 are connected about the first axis AX1 in a non-rotatable manner. For example, the optical engine module 200 has at least one fixing hole 200a1, while the carrier disk 400 has at least one through hole 400a2, wherein the fixing element 450 connects the fixing hole 200a1 with the through hole 400a2 along the Y-direction. As a result, when the carrier disk 400 rotates about the first axis AX1 (which is parallel to the X-direction), the optical engine module 200 and the carrier disk 400 rotate synchronously about the first axis AX1.

The second axis AX2 coincides with a central axis of the fixing hole 200a1, or the central axis of the fixing hole 200a1 defines the second axis AX2. The fixing element 450 is screwed into the fixing hole 200a1. In an embodiment, the fixing element 450 has, for example, a male thread, while the fixing hole 200a1 has, for example, a female thread that mates with the male thread.

As shown in FIGS. 1B and 12A to 12B, the carrier disk 400 has at least one through hole 400a2, and the fixing element 450 may disposed through the through hole 400a2. The fixing element 450 and the through hole 400a2 are, for example, a transition fit or a loose fit, so that the carrier disk 400 and the fixing element 450 rotate relative to each other about the second axis AX2, thereby allowing the optical engine module 200 (which is fixed to the fixing element 450) and the carrier disk 400 to rotate relative to each other about the second axis AX2. As a result, when the optical engine module 200 rotates about the second axis AX2, the carrier disk 400 does not move.

As shown in FIG. 12B, the pivot element 480 is connected to the drive module 500 and the optical engine module 200. As a result, when the drive module 500 drives the pivot element 480 to push the optical engine module 200, the optical engine module 200 rotates about the second axis AX2. Since the optical engine module 200 and the carrier disk 400 may rotate relative to each other about the second axis AX2, the carrier disk 400 does not rotate when the drive module 500 drives the pivot element 480 to push the optical engine module 200 to rotate about the second axis AX2.

As shown in FIGS. 12A and 12B, the optical engine module 200 has a through hole 200a2, the pivot element 480 has a through hole 480a1, and the connection element 490 connects the through hole 200a2 of the optical engine module 200 with the through hole 480a1 of the pivot element 480. As a result, the pivot element 480 and the optical engine module 200 may rotate relative to the connection element 490. In addition, the through hole 200a2, the through hole 480a1 and the connection element 490 are loosely fitted, for example, to provide the rotational DoF for the pivot element 480, the connection element 490 and the optical engine module 200 so that the rotational resistance of the optical engine module 200 is small or minimal (if the rotational resistance of the optical engine module 200 is large, it is possible to push the drive module 500 backward) when the drive module 500 drives the optical engine module 200 to rotate.

As shown in FIGS. 12A and 12B, the drive module 500 includes a second threaded rod 501. The pivot element 480 is connected to the optical engine module 200 and has a second screw hole 480a2. The second threaded rod 501 is screwed into the second screw hole 480a2. In the present embodiment, regardless of whether it is the first state, the second state or the third state, the second threaded rod 501 and the second screw hole 480b are both engaged. The second screw hole 480a2 extends along the X-direction, and the second screw hole 480a2 is spaced from the first axis AX1 along the Z-direction by a distance H2. As a result, when the second threaded rod 501 rotates about the X-direction, the pivot element 480 may move along the X-direction, thereby driving the optical engine module 200 to rotate about the second axis AX2. In an embodiment, when the second threaded rod 501 rotates about the -X-direction, the optical engine module 200 may rotate about the second axis AX2 in a first direction (for example, one of the +Y-direction and the -Y-direction); when the second threaded rod 501 rotates about the +X-direction, the optical engine module 200 may rotate about the second axis AX2 in a second direction (for example, the other of the +Y-direction and the -Y-direction). When knob 105 is in the second state, for each revolution of knob 105, the optical engine module 200 may rotate around the second axis AX2 by a second predetermined angle. The second predetermined angle depends on the thread design (for example, lead) of the second threaded rod 501, the design of the distance H2 and a reduction ratio of a gear set of a drive module; this is not limited in the embodiments of the present invention. In an embodiment, the second predetermined angle is, for example, 0.5 degrees.

As shown in FIGS. 12A and 12B, the drive module 500 includes, for example, the gear set (for example, a first gear 510, a second gear 513, a third gear 515, a fourth gear 520 and at least one fifth gear 525) and an adapter plate 530. The first gear 510 and the second gear 513 may be connected and rotate synchronously. The second gear 513 meshes with the third gear 515. The first gear 510, the second gear 513 and the third gear 515 are, for example, bevel gears. In addition, the first gear 510 and the second gear 513 are pivotally connected to the adapter plate 530, wherein the adapter plate 530 may be fixed to the casing 11 (not shown in FIGS. 12A and 12B) by, for example, screws. The third gear 515 and the fourth gear 520 are connected to each other and may rotate synchronously. The third gear 515 and the fourth gear 520 are sleeved on the fixing shaft 470 and are rotatable relative to the fixing shaft 470. For example, the third gear 515 and the fourth gear 520 are loosely fitted to the fixing shaft 470. The fourth gear 520 meshes with one of the fifth gears 525, while the others of the fifth gears 525 remain engaged. Thus, when the first gear 510 rotates, it may drive the second gear 513, the third gear 515, the fourth gear 520 and the plurality of fifth gears 525 to rotate synchronously. Furthermore, the plurality of fifth gears 525 may be pivotally connected to the carrier plate 400.

As shown in FIGS. 1C, 12A, and 12B, when the knob 105 is in the second state (as shown in FIG. 1C), the second engagement element 131 of the aforementioned clutch 130 may engage with the first gear 510. When the second engagement element 131 rotates around the third axis AX3, the first gear 510, the second gear 513, the third gear 515, the fourth gear 520 and fifth gears 525 are driven to rotate synchronously. The second threaded rod 501 is connected to the gear located at an end of a power transmission path among the plurality of gears of the drive module 500, for example, the fifth gear 525'. The second threaded rod 501 and the fifth gear 525' are fixed to rotate synchronously. When the knob 105 is in the second state (as shown in FIG. 1C), the knob 105 may rotate around the third axis X3 to drive the second threaded rod 501 to rotate around the X-direction, thereby driving the optical engine module 200 to rotate around the second axis AX2. Since the optical engine module 200 and the carrier disk 400 may rotate relative to each other around the second axis AX2, when the optical engine module 200 rotates around the second axis AX2, the carrier disk 400 does not rotate accordingly, and accordingly it prevents the relative relationship between the carrier disk 400 and the drive module 500 from easily changing.

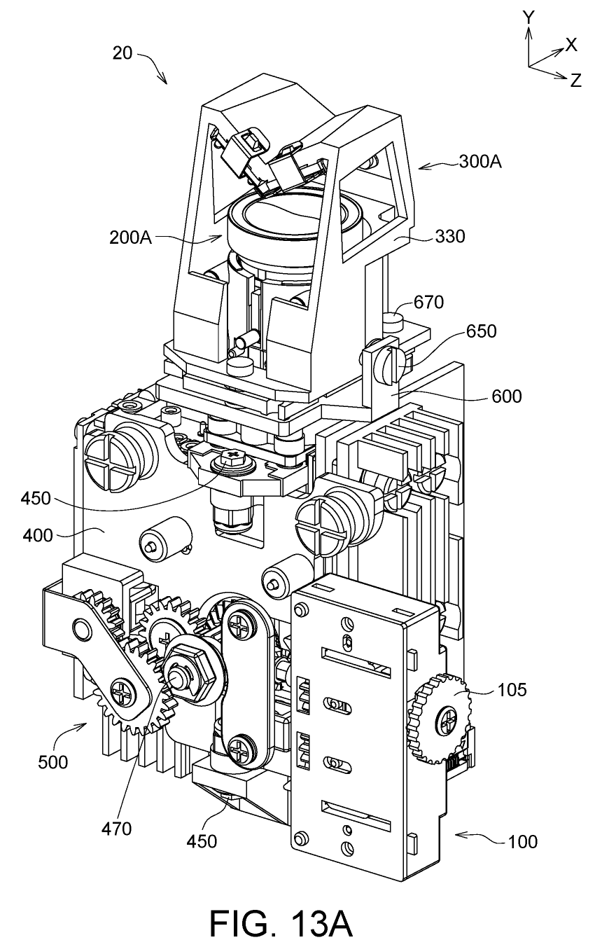

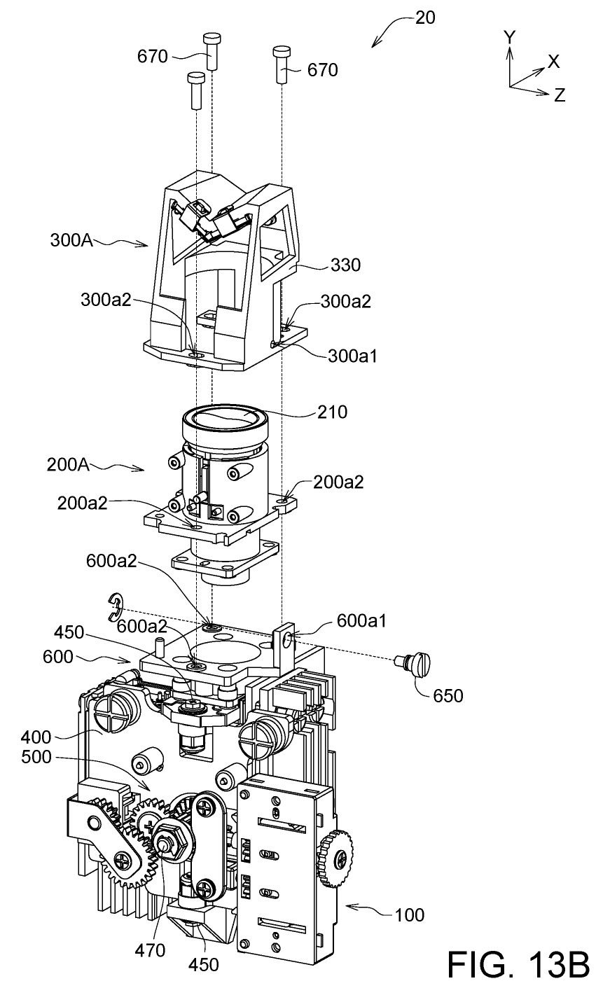

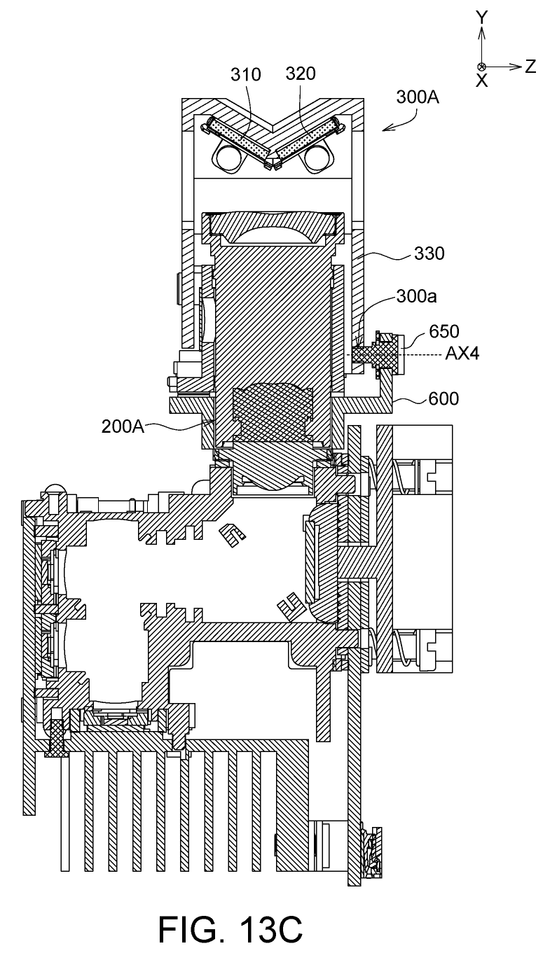

Referring to FIGS. 13A to 13C, FIG. 13A shows a schematic diagram of a projector 20 according to another embodiment of the present invention (the casing 11 is not shown), FIG. 13B shows an exploded view of the projector 20 in FIG. 13A, and FIG. 13C shows a cross-sectional view of the projector 20 in FIG. 13A along a direction 13B-13B'.

As shown in FIGS. 13A to 13C, the projector 20 includes the casing 11 (not shown), the adjustment module 100, the optical engine module 200A, a V-shaped reflector module 300A, the carrier disk 400, the fixing element 450, the fixing shaft 470, the pivot element 480 (not shown), the connection element 490 (not shown), the drive module 500, an adapter 600, a third threaded rod 650 and at least one fixing element 670. The projector 20 includes the same or similar technical features as the aforementioned projector 10, and at least one difference is that the V-shaped reflector module 300A and the optical engine module 200A are relatively displaceable, so that the position of the V-shaped reflector module 300A is adjustable relative to the optical engine module 200A.

As shown in FIGS. 13A to 13C, the V-shaped reflector module 300A includes a first reflective mirror 310, a second reflective mirror 320 and a carrier element 330. The carrier element 330 is movable relative to the optical engine module 200A, and the first reflective mirror 310 and second reflective mirror 320 are disposed on the carrier element 330 in a V-shape. The image projected by the optical engine module 200A is incident on the first reflective mirror 310 and second reflective mirror 320, and then reflected by the first reflective mirror 310 and second reflective mirror 320 to two areas of a dashboard respectively.

As shown in FIGS. 13A to 13C, the optical engine module 200A includes a lens 210. The adapter 600 is fixed to the optical engine module 200A. The V-shaped reflector module 300A is slidably connected to the optical engine module 200A. The third threaded rod 650 is rotatably connected to the V-shaped reflector module 300A. The V-shaped mirror module 300A has a third screw hole 300a1, wherein the third screw hole 300a1 is screwed into the third threaded rod 650. In the present embodiment, the third screw hole 300a1 is, for example, disposed on the carrier element 330. The third threaded rod 650 may drive the V-shaped mirror module 300A to move along a fourth axis AX4 for adjusting the relative position of the mirrors (for example, the first reflective mirror 310 and the second reflective mirror 320) and the optical engine module 200A along the fourth axis AX4. In the present embodiment, the fourth axis AX4 is parallel to the Z-direction; however, in another embodiment, depending on the extension direction of the central axis of the third screw hole 300a1, the fourth axis AX4 may be parallel to the X-direction. In the present embodiment, the third screw hole 300a1 extends, for example, along the Z-direction; in another embodiment, the third screw hole 300a1 may extend along the X-direction.

As shown in FIGS. 13A to 13C, the adapter 600 has a through hole 600a1. The aforementioned third threaded rod 650 passes through the through hole 600a1 and is screwed into the third screw hole 300a1 of the V-shaped reflector module 300A. In the present embodiment, the through hole 600a1 and the third threaded rod 650 are rotatable relative to each other. For example, the through hole 600a1 and the third threaded rod 650 are loosely fitted, so that the third threaded rod 650 rotates relative to the adapter 600.

As shown in FIGS. 13A to 13C, the V-shaped reflector module 300 also has at least one elongated hole 300a2, wherein the elongated hole 300a2 may be disposed on the support element 330. In the present embodiment, a long axis of the elongated hole 300a2 extends parallel to an extension direction of the fourth axis AX4 for providing a travel distance for the V-shaped reflector module 300 along the fourth axis AX4.

As shown in FIGS. 13A to 13C, the optical engine module 200A has at least one through hole 200a2, and the adapter 600 further has at least one fixing hole 600a2. The fixing element 670 passes through the elongated hole 300a2 and the through hole 200a2 and is fixed to the fixing hole 600a2. The fixing element 670 and the through hole 200a2 are, for example, loosely fitted, and the fixing element 670 and the elongated hole 300a2 are, for example, loosely fitted. In an embodiment, the fixing element 670 has, for example, a male thread, and the fixing hole 600a2 has, for example, a female thread that mates with the male thread. In addition, an outer diameter of the fixing element 670 is approximately equal to an inner diameter of the fixing hole 600a2, so that there is no relative movement between the fixing element 670 and the adapter 600 along the XY-plane. In addition, the adapter 600 is fixed to the carrier disk 400. As a result, there is no relative movement between the carrier disk 400, the adapter 600 and the optical engine module 200A.

In summary, this invention provides a projector including an adjustment module and an optical engine module. The adjustment module includes a knob, wherein the knob may be in different states to operate different movement modes of the optical engine module. When the knob is in the first state, the knob may be rotated to drive the optical engine module to rotate around a first axis. When the knob is in the second state, the knob may be rotated to drive the optical engine module to rotate around a second axis. As a result, by operating the same knob in different states, the optical engine module may be driven to rotate around different axes. In the present embodiment, as long as the projector has the adjustment module and has optical engine module, it may achieve the adjustment function (that is, the optical engine module rotates around different axes). In addition, as long as the adjustment function may be achieved, the embodiments of the present invention do not limit the mechanisms and/or structures of the each component of the projector, and the mechanisms and/or structures of each component of the projector of the present invention are not limited to the foregoing embodiments. In another embodiment, when the knob is in the third state, the knob cannot be turned (locked state), and accordingly it may prevent the knob from being easily turned due to accidental touch.

While the invention has been described by way of example and in terms of the preferred embodiment (s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A projector adapted to be disposed on a mobile carrier, comprising:
an optical engine module; and
an adjustment module connected to the optical engine module and comprising a knob;
wherein based on the knob being in a first state, the optical engine module is allowed to rotate about a first axis; based on the knob being in a second state, the optical engine module is allowed to rotate about a second axis; the first axis and the second axis have different directions.

2. The projector according to claim 1, wherein the adjustment module comprises:
a first housing;
a first engagement element rotatably disposed in the first housing; and
a clutch connected to the knob, slidably disposed relative to the first housing and comprising a second engagement element;
wherein based on the knob being in the first state, the second engagement element engages with the first engagement element; based on the knob being in the second state, the second engagement element disengages from the first engagement element.

3. The projector according to claim 2, wherein the adjustment module further comprises:
a third engagement element, rotatably disposed on the first housing and engaged with the first engagement element.

4. The projector according to claim 3, wherein the adjustment module further comprises a first threaded rod connected to the third engagement element, and the projector further comprises:
a carrier disk connected to the optical engine module and having a first screw hole, wherein the first screw hole is screwed into the first threaded rod;
wherein based on the knob being in the first state and the knob rotating, the first threaded rod rotates to drive the carrier disk and the optical engine module to rotate about the first axis.

5. The projector according to claim 2, wherein the adjustment module comprises:
a sliding plate slidably disposed on the first housing;
wherein the clutch is rotatably but non-slidably connected to the sliding plate.

6. The projector according to claim 2, further comprising:
a drive module comprising a second threaded rod; and
a pivot element connected to the optical engine module and having a second screw hole, wherein the second screw hole is screwed into the second threaded rod;
wherein based on the knob being in the second state, the second engagement element is engaged with the drive module; based on the knob being in the second state and the knob rotating, the second threaded rod rotates to drive the optical engine module to rotate about the second axis.

7. The projector according to claim 6, wherein the drive module is a gear set.

8. The projector according to claim 6, wherein the drive module comprises a plurality of gears, and the second threaded rod is connected to one of the gears which is located at an end of a power transmission path.

9. The projector according to claim 1, further comprising:
a carrier disk; and
a fixing element fixed to the optical engine module and rotatably pivotally connected to the carrier disk about the second axis.

10. The projector according to claim 1, wherein the knob has a knob engagement portion, and the adjustment module further comprises:
a second housing having a housing engagement portion;
wherein based on the knob being in a third state, the knob engagement portion engages with the housing engagement portion.

11. The projector according to claim 1, further comprising:
a casing having an outer surface;
wherein based on the knob being in the first state, the knob protrudes relative to the outer surface.

12. The projector according to claim 1, further comprising:
a casing having an outer surface;
wherein based on the knob being in a third state, the knob is flush with or recessed relative to the outer surface of the casing.

13. The projector according to claim 12, wherein the casing further has a groove, the groove is recessed relative to the outer surface, the groove has a groove length and the knob has a knob length along the same direction, and the groove length is greater than the knob length.

14. The projector according to claim 1, wherein the adjustment module further comprises:
a sliding element having a first recess and a second recess;
a spring piece having an end portion;
wherein based on the knob being in the first state, the end portion of the spring piece engages with the first recess; based on the knob being in the second state, the end portion of the spring piece engages with the second recess.

15. The projector according to claim 10, wherein the adjustment module further comprises:
a sliding plate having a recessed hole; and
a latch having an end portion;
wherein based on the knob being in the first state or the second state, the end portion of the latch is located within the recessed hole of the sliding plate.

16. The projector according to claim 15, wherein the adjustment module further comprises:
an elastic element disposed between the latch and the sliding plate.

17. The projector according to claim 15, wherein based on the knob switching from the second state to the third state, the end portion of the latch disengages from the recessed hole of the sliding plate.

18. The projector according to claim 1, further comprising:
a V-shaped reflector module disposed relative to the optical engine module.

19. The projector according to claim 18, wherein the optical engine module comprises a lens, and the projector further comprises:
an adapter fixed to the optical engine module; and
wherein the V-shaped reflector module is translatably disposed relative to the lens of the optical engine module.

20. The projector according to claim 19, further comprising:
a third threaded rod rotatably connected to the adapter;
wherein the V-shaped reflector module has a third screw hole, and the third screw hole is screwed into the third threaded rod.
